(19) United States
(12) Patent Application Publication
(10) Pub. No.: US 2026/0289983 A1
(43) Pub. Date: Sep. 24, 2026

(54) SYSTEM

(71) Applicant: SoftBank Group Corp., Tokyo (JP)

(72) Inventor: Masaharu SHIRAKAWA, Tokyo (JP)

(73) Assignee: SoftBank Group Corp., Tokyo (JP)

(21) Appl. No.: 19/567,391

(22) Filed: Mar. 16, 2026

(30) Foreign Application Priority Data
Mar. 19, 2025 (JP) 2025-044976

(51) Int. Cl. G06V 10/776; G06V 10/77; G06V 20/64

(52) U.S. Cl. CPC G06V 10/776; G06V 10/7715; G06V 20/64

(57) ABSTRACT

A system includes a processor that is configured to receive visual data of a facility, input a prompt to a generative AI model to instruct the generative AI model to generate barrier-free information based on the visual data, cause the generated barrier-free information to be displayed via a user interface, and automatically generate an improvement proposal for the facility based on feedback from a user.

### CROSS-REFERENCE TO RELATED APPLICATION

This application is based on and claims priority under 35 USC 119 from Japanese Patent Application No. 2025-044976 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Modern facilities such as hotels, commercial buildings, and public institutions are increasingly required to provide accurate and up-to-date barrier-free information to users, including elderly persons and persons with disabilities. Conventionally, barrier-free information has been created and maintained manually by facility staff, based on on-site inspections, subjective evaluations, and handwritten or manually edited reports. Such manual processes are time-consuming, prone to human error and inconsistency, and often fail to reflect the actual current state of the facility when renovations or layout changes occur. Furthermore, even when barrier-free information is provided on a website or brochure, the information is frequently limited, descriptive, and not standardized, making it difficult for users to compare different facilities or to determine whether a particular facility truly meets their accessibility needs. In addition, although facility operators may receive feedback from users regarding barrier-free issues, the feedback is often unstructured and not systematically analyzed, so that concrete and effective improvement proposals are not automatically derived. As a result, there is a need for a technique that can automatically generate barrier-free information from visual data of a facility, present the generated barrier-free information to users, and further utilize user feedback to automatically generate improvement proposals that support the promotion of barrier-free measures for the facility.

### SUMMARY

In order to solve at least part of the above-described problems, according to one aspect of the present invention, there is provided a system comprising a processor, wherein the processor is configured to receive visual data of a facility, input a prompt to a generative AI model to instruct the generative AI model to generate barrier-free information based on the visual data, cause the generated barrier-free information to be displayed via a user interface, and automatically generate an improvement proposal for the facility based on feedback from a user. In one embodiment, the processor is configured to input, as the prompt, information including features extracted from the visual data of the facility in order to instruct the generative AI model to generate the barrier-free information. By extracting features from the visual data and using the extracted features in the prompt, the generative AI model can generate barrier-free information that reflects objective characteristics of the facility, such as the presence or absence of steps, ramps, elevators, and accessible restrooms. In another embodiment, the processor is configured to automatically generate, based on the feedback from the user, the improvement proposal that contributes to promotion of barrier-free measures of the facility. By systematically analyzing user feedback together with the generated barrier-free information, the system can propose specific measures, such as installation of ramps, addition of elevators, or remodeling of restrooms, thereby supporting continuous improvement of barrier-free accessibility in the facility.

The term “system” refers to an apparatus including at least one processor and, optionally, one or more memories, communication interfaces, input/output devices, user interfaces, or other hardware or software components that cooperate to execute the processing described in the present specification and claims.
The term “processor” refers to any hardware component capable of executing instructions, such as a central processing unit (CPU), a graphics processing unit (GPU), a digital signal processor (DSP), an application specific integrated circuit (ASIC), a field programmable gate array (FPGA), or a combination thereof, and may include a single processor or a plurality of processors operating in cooperation.
The term “visual data” refers to data representing an appearance of at least a part of a facility, including but not limited to still images, moving images, video streams, or sequences of image frames, and may be obtained by a camera, a smartphone, a surveillance system, or any other imaging device.
The term “facility” refers to any building, structure, or site that is used by users, including, for example, hotels, inns, commercial buildings, office buildings, public facilities, transportation facilities, hospitals, schools, recreational facilities, or other places where barrier-free accessibility is of concern.
The term “generative AI model” refers to a machine learning model configured to generate information, text, or other content in response to input data and a prompt, and includes, for example, large language models, multimodal generative models, or other generative models trained on datasets to output barrier-free information based on visual data of a facility.
The term “prompt” refers to information supplied to the generative AI model as an input instruction, including natural language text, structured data, or a combination thereof, which causes the generative AI model to generate barrier-free information corresponding to the visual data of the facility.
The term “barrier-free information” refers to information indicating accessibility-related characteristics of the facility, including, for example, presence or absence of steps, ramps, elevators, handrails, accessible restrooms, door widths, slopes, or other elements that affect usability for elderly persons, persons with disabilities, or users with limited mobility.
The term “user interface” refers to any hardware and software components that enable a user to view or interact with information provided by the system, including, for example, a display screen, a web browser interface, a mobile application interface, a dashboard, or a graphical user interface (GUI).
The term “feedback” refers to information provided by a user regarding barrier-free aspects of the facility or the generated barrier-free information, including comments, evaluations, ratings, selections, corrections, or other responses entered through the user interface or other communication means.
The term “improvement proposal” refers to information generated by the system that recommends or specifies one or more actions to improve barrier-free accessibility of the facility, including, for example, installation of ramps, addition or modification of elevators, renovation of restrooms, adjustment of layouts, or other construction or operational measures. The term “features extracted from the visual data” refers to information derived from the visual data through image processing or machine learning, including detected objects, regions, patterns, measurements, classifications, labels, or other attributes that represent structural or functional characteristics of the facility relevant to barrier-free accessibility.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

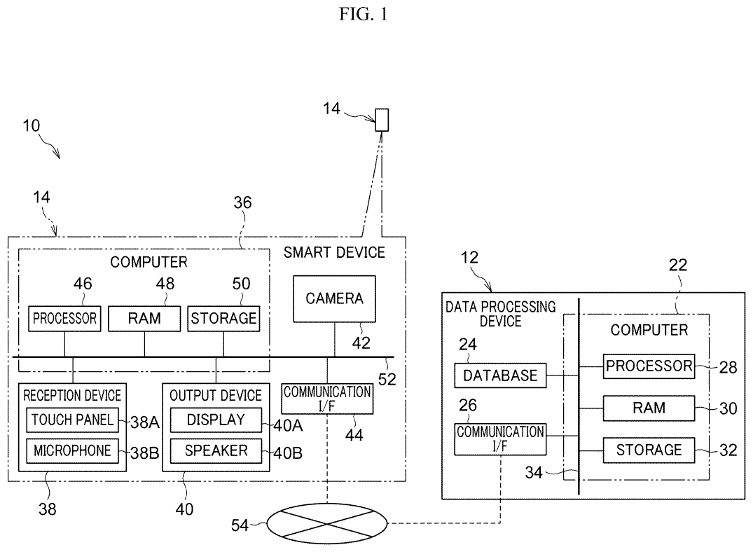

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

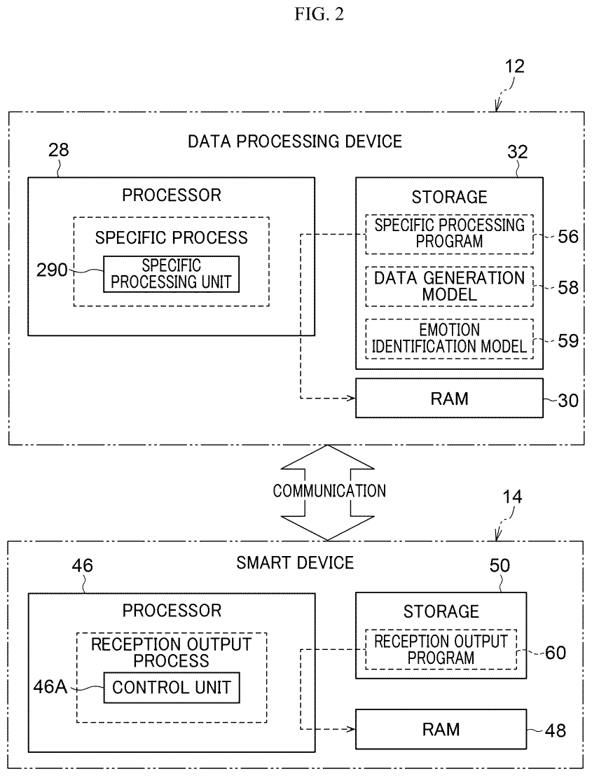

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional techniques for providing accessibility or barrier-free information about facilities rely heavily on manual inspection and manual text authoring. Human operators typically review images, videos, or on-site survey results, then manually classify the accessibility status of pathways, elevators, and sanitary installations, and finally draft descriptive text for publication on web pages or other information media. This workflow is time-consuming, costly, and error-prone, and cannot scale efficiently as the number of facilities or the frequency of updates increases.
At the same time, typical computer-implemented accessibility information systems process images only to detect objects or simple labels, and do not effectively combine lower-level visual features with higher-level natural-language generation. In many existing systems, object detection and text generation are separate, loosely coupled processes. As a result, the generated descriptions are often generic, may not accurately reflect the detected features, and may not be easily consumable by users who need clear, actionable accessibility information. Furthermore, conventional systems do not effectively exploit user feedback to iteratively improve both the quality of accessibility descriptions and the quality of proposals for facility improvement. Feedback is often stored in unstructured form and remains unused for systematic refinement of computer-based models or for automated generation of improvement proposals. This limits the ability of the system to learn from real user experiences, and leads to static accessibility information that does not reflect actual user needs.
From a computer-technology standpoint, existing solutions lack an integrated processing pipeline that: (i) efficiently converts raw visual data into normalized analysis data suitable for machine learning inference; (ii) extracts structured, machine-readable accessibility features using image recognition; (iii) conditions a generative model via prompt sentences that embed those structured features; and (iv) automatically produces both machine-readable records and human-readable explanations in a consistent manner. The absence of such a pipeline causes redundant processing, increases latency, and degrades the consistency and reliability of generated outputs across different components of the system.
Accordingly, there is a need for an improved computer-implemented system that can automatically preprocess facility visual data, extract structured accessibility-related features, construct prompt sentences embedding those features, invoke a generative model to produce accurate natural-language descriptions, and further generate structured improvement proposals based on user feedback. Such a system should improve the efficiency, scalability, and technical reliability of generating and updating barrier-free information across various information providing media.

The specific processing by the specific processing unit 290 of the data processing device 12 in Example 1 is realized by the following means.

The present invention provides a server comprising a processor configured to receive visual data of a facility from a user terminal, convert the visual data into normalized analysis data, execute a machine-learning-based image recognition process on the analysis data to extract accessibility-related features including presence or absence of level differences, installation status of lifting equipment, and accessibility status of sanitary equipment, generate structured data representing barrier-free information based on the extracted features, automatically construct a prompt sentence embedding the structured data to instruct a generative information processing model to generate a natural-language explanation, input the prompt sentence into the generative information processing model and acquire the generated natural-language explanation, present the structured data and the natural-language explanation via a user interface, automatically generate improvement proposal information for the facility based on user feedback information acquired via the user interface and the extracted features, and convert and distribute the barrier-free information and the improvement proposal information in a format suitable for publication to an information providing medium. This enables an integrated, computer-implemented pipeline that technically improves the automatic generation and update of accurate, consistent, and user-adapted barrier-free information, reduces manual processing load, and enhances the efficiency and reliability with which accessibility information and improvement proposals are produced and delivered by the server.

The term “system” refers to a combination of hardware and software components including at least one processor and associated storage, communication, and interface resources configured to execute the processing described in the claims.
The term “processor” refers to a hardware information processing unit, such as a central processing unit or a processing circuit, capable of executing instructions to perform data processing, analysis, and control operations.
The term “user terminal” refers to an information processing device operated by a user, such as a mobile device, a portable computer, or a fixed terminal, configured to capture, store, or transmit visual data and to display information via a user interface.
The term “visual data” refers to data representing visual information of a facility, including still image data, moving image data, or any other data from which visual characteristics of the facility can be derived.
The term “facility” refers to a physical place, building, or site, including public or private spaces, for which accessibility or barrier-free information is to be generated.
The term “analysis target data” refers to data derived from the visual data by preprocessing, including resized, normalized, or otherwise transformed image or video frame data suitable as input to a machine learning model.
The term “machine learning” refers to a class of computational techniques in which a model is trained on data to perform tasks such as classification, detection, or recognition without being explicitly programmed with rule-based logic for each possible input.
The term “image recognition process” refers to a computer-implemented operation that analyzes image or video data to identify, classify, or locate objects, structures, or patterns within the data.
The term “barrier-free related features” refers to machine-readable attributes extracted from visual data that are relevant to accessibility, including indicators of the presence or absence of level differences, the installation status of lifting equipment, and the accessibility status of sanitary equipment.
The term “level differences” refers to discontinuities in floor height or surface elevation within or around a facility, including steps, curbs, or other changes in level that may affect accessibility.
The term “lifting equipment” refers to devices for vertical transportation of persons or goods within a facility, including elevators, platform lifts, and other mechanical lifting means relevant to accessibility.
The term “sanitary equipment” refers to installations and fixtures associated with restrooms or similar sanitary spaces, including toilets, washbasins, handrails, and doorways, which may have features that affect accessibility.
The term “structured data” refers to data organized in a predefined format, such as a set of fields, records, or key-value pairs, enabling systematic processing by a computer program.
The term “barrier-free information” refers to information describing the accessibility characteristics of a facility, including the status of level differences, lifting equipment, and sanitary equipment, in a form suitable for interpretation by users or other systems.
The term “generative information processing model” refers to a computational model, such as a generative artificial intelligence model, that generates output data including natural-language text in response to input data and instructions.
The term “prompt sentence” refers to a sequence of natural-language or structured instructions provided as input to a generative information processing model to specify or constrain the content, style, or structure of the generated output.
The term “natural-language explanation” refers to text generated in a human language that describes barrier-free information in a form understandable to human users.
The term “user interface” refers to a hardware and software interface through which a user can view information or input data, including graphical displays, input fields, and interactive elements.
The term “user feedback information” refers to data provided by a user through the user interface, including evaluations, comments, selections, or other input that reflects the user's assessment or experience regarding a facility's accessibility.
The term “improvement proposal information” refers to information automatically generated by the system that suggests changes, additions, modifications, or rearrangements of structural or equipment elements of a facility to enhance accessibility.
The term “structural elements” refers to components forming the physical configuration of a facility, including walls, floors, entrances, ramps, and passageways.
The term “equipment elements” refers to non-structural devices or installations within a facility, including lifting equipment, sanitary equipment, signage, and other fixtures that may affect accessibility.
The term “information providing medium” refers to a platform or means for distributing information to users, including network-based services, websites, or other digital publication environments.
The term “publishable format” refers to a data representation, including markup, structured records, or formatted text, that is suitable for distribution or display by an information providing medium.

In one embodiment, a server, one or more terminals, and one or more users cooperate to implement the claimed system.
The server includes at least one processor, a main memory, a non-volatile storage device such as a solid-state drive, and a network interface. The server executes an operating system such as a general-purpose server operating system and application software implemented, for example, in a high-level programming language. The server further executes software libraries for image processing and machine learning, such as an image processing library (e.g., OpenCV or an equivalent), a numerical computation library (e.g., a tensor library), and a deep learning framework (e.g., a general-purpose deep learning framework such as a tensor-based framework or a dynamic-graph framework). The server may also include a graphics processing unit configured to accelerate parallel numerical computation, such as convolution operations and matrix multiplications used in neural networks.
The terminal includes a processor, a memory, a display, one or more input devices such as a touchscreen, and a communication interface. The terminal executes a web browser or a native application that presents a graphical user interface to the user. The user operates the terminal to capture or select visual data of facilities, such as images or videos, and to view barrier-free information and improvement proposals generated by the server.
The user operates the terminal to select facility visual data stored in a local storage, for example photographs of a hotel lobby, corridors, entrances, or restrooms. The terminal transmits the selected image or video files to the server via a network using a communication protocol such as HTTPS. The transmission uses structured requests, such as multipart requests, including metadata about the facility or context when available.
The server receives the visual data and stores the raw files in a storage device. The server uses the image processing library to convert the visual data into analysis target data. The server resizes images to a predefined resolution, for example 640×480 pixels or 512×512 pixels, and normalizes pixel values to a standard range such as [0,1] or [−1,1]. The server converts video files into sequences of frames at a defined frame rate, such as one frame per second, and discards intermediate frames that are unlikely to add new structural information. The server applies noise reduction filters, such as Gaussian filters or median filters, and adjusts brightness and contrast by histogram equalization or gamma correction. By normalizing the visual data in this way, the server reduces variation due to different capture devices and lighting conditions, thereby improving the performance and robustness of subsequent machine learning inference.
The server uses a deep learning framework to load one or more trained models configured for facility accessibility feature extraction. In one embodiment, the server uses a convolutional neural network (CNN) having multiple convolutional layers, non-linear activation layers, pooling layers, and fully connected layers. The CNN may be configured in an object detection architecture, for example a one-stage detector or two-stage detector, that outputs bounding boxes, class scores, and confidence values. In another embodiment, the server uses a hybrid architecture combining a CNN backbone with an attention mechanism or a transformer-based module to capture spatial relationships between detected structures such as steps, ramps, doorways, and elevators.
The server applies the trained model to the analysis target data. The server arranges preprocessed images or frames into mini-batches of a predetermined size, encodes them as tensors, and forwards them through the neural network using numerical kernels optimized for the graphics processing unit. The server obtains, for each image or frame, a set of candidate detections each associated with a class label (for example, step, ramp, elevator door, doorway, handrail, toilet bowl, sink, sign, corridor) and a confidence score. The server applies non-maximum suppression to remove overlapping bounding boxes with lower confidence values and filters out detections below a threshold value, such as 0.5. By performing this selective filtering, the server limits the number of downstream features, reducing memory usage and processing time while maintaining accuracy.
The server aggregates detections across multiple frames originating from a given video. The server uses temporal grouping logic, for example, by clustering detections with similar spatial locations across consecutive frames, to differentiate stable structural elements from transient objects such as people. The server labels clusters that persist over a minimum number of frames as structural elements and discards clusters that appear only briefly. This temporal filtering reduces false positives due to transient occlusions and improves the precision of barrier-free related features.
The server converts the filtered detections into structured data. The server defines a schema, for example with fields such as “has_step_at_entrance,” “has_ramp_near_step,” “has_lift_in_lobby,” “has_wide_door_in_restroom,” “has_grab_bar_in_restroom,” “has_clear_path_width,” and related attributes. The server maps specific detection patterns to these fields according to rule-based logic. For instance, when the server detects an object classified as “elevator door” in proximity to an object classified as “lobby signage” or “reception desk,” the server sets a field “has_lift_in_lobby=true.” When the server detects an object classified as “step” at the boundary region of the image designated as an entrance area and does not detect an associated “ramp” object within a defined spatial neighborhood, the server sets “has_step_at_entrance=true” and “has_ramp_near_step=false.” By employing this structured mapping, the server transforms unstructured neural network outputs into semantically meaningful, machine-readable accessibility features. This process is not a simple human equivalent of reading an image; instead, the server uses non-obvious spatial and temporal thresholds and clustering rules that are tuned to the numerical behavior of the underlying neural network outputs. These rules reduce ambiguity and enable deterministic interpretation of probabilistic detections, thereby improving repeatability and enabling subsequent computational processing.
The server uses a database management system to store the structured data as records associated with respective facilities. Each record can include a facility identifier, timestamps, links to the source visual data, and the computed barrier-free related features. This structured storage allows the server to retrieve and update facility accessibility information efficiently and to index facilities based on accessibility properties, which is difficult to achieve consistently when relying solely on manually created text descriptions.
The server constructs a prompt sentence to condition a generative AI model. The server embeds the structured data into a natural-language instruction. For example, the server may generate a prompt sentence such as:
“You are an assistant that describes accessibility information. Based on the following detection results: steps present at the main entrance, elevator detected near the lobby reception, no accessible toilet detected in the images, generate a clear and concise explanation of the facility's barrier-free status for wheelchair users in English.”
In another example, the server may generate a prompt sentence such as:
“From this image, extract barrier-free information. Specifically, check for the presence or absence of steps, the installation status of elevators, and the accessibility of toilets. Then generate a short summary suitable for display on a public website.”
The server can adjust the level of detail or target audience by modifying the wording or constraints in the prompt sentence. Because the server automatically builds the prompt sentence from the structured data, the generative AI model receives precise and constrained instructions reflecting the actual detection results. This reduces the likelihood of hallucinated content and improves the alignment between the generated natural-language explanation and the underlying visual analysis.
The server communicates with the generative AI model via an application programming interface. The server transmits the prompt sentence and, when supported, references to representative images or thumbnails associated with the structured data. The generative AI model may be implemented as a neural network using a transformer architecture, trained on large corpora of text and optionally multimodal data. The server sets model parameters, for example temperature and maximum output length, to balance consistency and expressiveness. The server receives the natural-language explanation generated by the generative AI model and stores it as part of the facility record. The server associates each explanation with the corresponding structured data and metadata. By maintaining this linkage, the server enables verification and later re-generation of explanations when the structured data changes, without needing to reprocess the original visual data.
The server uses the user interface on the terminal to present both the structured barrier-free information and the natural-language explanation. The terminal displays key indicators, for example with icons or labels indicating availability of elevators, presence of steps at entrances, and status of accessible toilets. The terminal also displays the generated explanatory text, which may summarize the structured indicators and highlight considerations for particular user groups. The user reads this information and, when desired, provides feedback through the interface in the form of ratings, comments, corrections, or suggestions. The server receives the user feedback information and stores it in association with the corresponding facility and barrier-free features. The server uses rule-based logic and statistical analysis to derive improvement proposal information. For example, when multiple users report difficulty entering a lobby where the structured data indicates “has_step_at_entrance=true” and “has_ramp_near_step=false,” the server generates a proposal suggesting installation of a ramp or modification of the entrance to remove the step. When user feedback indicates overcrowding near a lift and the structured data indicates “has_lift_in_lobby=true” but does not indicate alternate accessible routes, the server generates a proposal suggesting additional signage or redistribution of accessible pathways. In some embodiments, the server uses a secondary machine learning model trained on historical pairs of barrier-free features and human-curated improvement proposals to suggest new proposals. The server encodes the structured data and user feedback as feature vectors and feeds them to a learned model, such as a feed-forward neural network or a gradient-boosted decision tree. The server outputs proposal categories, for example “install ramp,” “widen doorway,” “add grab bars,” or “improve signage,” together with confidence scores. The server can then convert these categories into human-readable improvement proposal information using templates or additional natural-language generation. The server publishes the barrier-free information and improvement proposals to information providing media, such as websites or other digital platforms. The server converts the structured data and explanations into formats such as markup or structured feeds and transmits them via network protocols to external systems. The server may use caching, compression, and incremental update techniques so that only changed fields or segments are transmitted when facility information is updated, thereby reducing communication load and improving responsiveness.
From a technical standpoint, this configuration improves computer technology in several ways. First, the server implements a dedicated preprocessing pipeline that normalizes heterogeneous visual data into analysis target data optimized for neural network inference. This reduces inference variance and enables more efficient use of hardware acceleration, thereby improving processing speed and throughput. Second, by converting dense detection outputs into constrained structured data using domain-specific mapping rules, the server reduces the dimensionality of information passed to the generative AI model. This leads to more efficient text generation, lower memory consumption, and improved consistency between visual recognition and natural-language output.
Third, the automatic construction of prompt sentences from structured data provides a non-conventional interface between vision models and language models. Instead of simply automating manual text drafting, the server uses programmatically generated prompts that encode machine-readable features in natural-language form. This controlled conditioning leads to higher precision and lower error rates in generated descriptions, which can be empirically evaluated by comparing generated text against ground truth derived from visual annotations or user feedback.
Fourth, the integration of user feedback into a structured improvement proposal generation process allows the server to refine internal mapping rules and statistical models over time, based on data that would be impractical for humans to analyze manually at scale. The server can, for example, adjust thresholds for detection confidence or spatial grouping based on feedback patterns indicating false positives or false negatives. This feedback-driven adaptation leads to measurable reductions in misclassification and more accurate accessibility assessments.
In training the neural networks used for image recognition, the server (or an associated training system) constructs a training dataset of annotated facility images and videos. Each sample includes labels for relevant objects and attributes, such as step presence, ramp geometry, door width, presence of grab bars, and elevator placement. The training process uses an error function such as a combination of localization loss (e.g., smooth L1 loss) and classification loss (e.g., cross-entropy loss). The network weights are updated using an optimization algorithm such as stochastic gradient descent with momentum or an adaptive method such as Adam. The server applies data augmentation techniques, such as random cropping, horizontal flipping, brightness and contrast adjustments, and perspective transformations, to improve robustness to varied real-world conditions. This training procedure yields a model that is specifically adapted to facility accessibility analysis, not a generic image classifier.
In another embodiment, the server uses a segmentation-based network architecture, in which each pixel of the image is assigned a class label such as floor, obstacle, step edge, ramp surface, or door opening. The server then derives geometric properties such as ramp slope or doorway width from the segmentation map by computing distances and angles in image coordinates and, when calibration data is available, converting them to real-world measurements. This additional geometric analysis enables the server to distinguish between compliant and non-compliant accessibility features based on regulatory thresholds.
The terminal can be implemented as a mobile device, wherein the user captures images in real time using a built-in camera. The terminal compresses and transmits the captured frames to the server. In some embodiments, the terminal performs lightweight preprocessing, such as down-sampling or format conversion, to reduce bandwidth requirements. The server then performs the more computationally intensive recognition and generation steps. This division of labor between the server and the terminal contributes to communication load reduction and enables real-time or near-real-time feedback to the user in the field.
Multiple alternative configurations are possible. The server may host the generative AI model locally, or the server may act as a client of a remote generative AI service. The structured data schema may be extended to include additional accessibility aspects, such as tactile paving, visual signage contrast, or acoustic guidance devices. The image recognition model may be replaced or complemented by models using three-dimensional data from depth sensors or point clouds, which the server can process using specialized 3D neural network architectures. The improvement proposal generation may be implemented purely by deterministic rules in environments where regulatory requirements are strict, or by a combination of rules and learned models where flexibility is desirable.
In each of these embodiments, the server implements concrete data structures, algorithmic flows, and model architectures that collectively provide a technical solution beyond mere automation of human cognitive tasks. The server improves the speed, scalability, and accuracy with which barrier-free information is created, updated, and disseminated, thereby enhancing the technical performance of computing systems used for facility accessibility analysis and information provision.

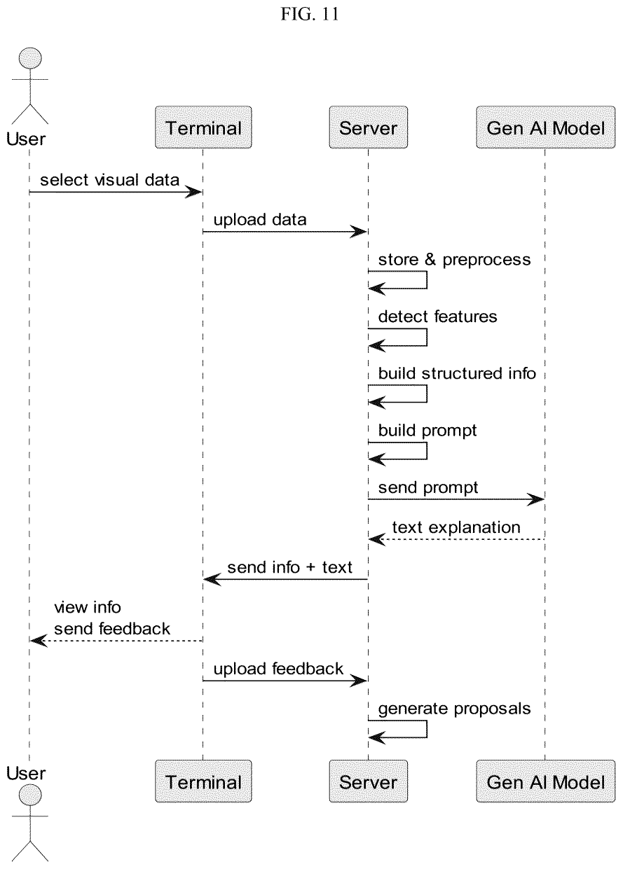

The following describes the processing flow using FIG. 11.
Step 1:
The user operates the terminal to select one or more facility images or videos from local storage.
The input is raw visual files (for example, JPEG images or MP4 videos) stored on the terminal.
The terminal opens a file selection interface and, based on the user's selection, associates metadata such as facility name or location if available.
The terminal sends the selected visual files and metadata to the server via a network request.
The output is a network payload containing the raw visual data and optional metadata transmitted to the server.
Step 2:
The server receives the network payload from the terminal and stores the raw visual data in non-volatile storage.
The input is the uploaded visual files and associated metadata received over the network.
The server validates file types and sizes, assigns internal identifiers, and records storage paths and timestamps in a database.
The server writes the raw binary content of the files to a file system or object storage and links the database records to the stored files.
The output is a set of stored visual data objects and corresponding database entries that reference these objects.
Step 3:
The server converts the stored visual data into analysis target data suitable for machine learning inference.
The input is the raw visual data objects (images or videos) referenced by the database entries.
The server uses an image processing library to decode each file, resample image resolution to a predetermined size, normalize pixel values, and apply noise reduction and brightness/contrast adjustment.
For video data, the server extracts frames at a fixed interval and discards redundant frames, then converts the frames into a uniform color space required by the model.
The output is a collection of normalized image tensors or frame tensors registered in memory or temporary storage as analysis target data.
Step 4:
The server applies a trained image recognition model to the analysis target data to detect accessibility-related objects.
The input is the normalized image or frame tensors prepared in Step 3.
The server batches the tensors, loads a pre-trained convolutional neural network or similar architecture, and forwards the batched tensors through the network layers using GPU acceleration.
The server obtains, for each image or frame, raw detection results including bounding boxes, class scores, and confidence values for object categories such as step, ramp, elevator, doorway, handrail, and sanitary fixture.
The output is a set of detection results containing object locations, labels, and confidence scores for each analyzed image or frame.
Step 5:
The server filters and aggregates the detection results to extract stable barrier-free related features.
The input is the per-image or per-frame detection results produced in Step 4.
The server applies non-maximum suppression to remove overlapping boxes with lower confidence, discards detections below a threshold, and groups detections across temporally adjacent frames in the case of video.
The server identifies persistent structural objects and eliminates transient objects, then summarizes the remaining detections as candidate barrier-free related features.
The output is a refined feature set describing detected structural elements relevant to accessibility with reduced noise and redundancy.
Step 6:
The server maps the refined features into structured barrier-free information according to predefined rules.
The input is the refined feature set representing detected accessibility-related objects and their attributes.
The server evaluates spatial relationships, such as proximity of steps to entrances or ramps to steps, and uses rule-based logic to set structured fields such as “has_step_at_entrance,” “has_lift_in_lobby,” and “has_accessible_toilet.”
The server compiles these fields into a structured record using a defined schema and associates the record with the corresponding facility in the database.
The output is a structured barrier-free information record stored as machine-readable data.
Step 7:
The server constructs a prompt sentence for a generative AI model using the structured barrier-free information.
The input is the structured barrier-free record generated in Step 6.
The server selects relevant fields and converts them into natural-language fragments, then assembles them into a coherent instruction that constrains the content and style of the desired explanation.
The server, for example, generates a prompt sentence such as: “You are an assistant that describes accessibility information. Based on the following detection results: steps present at the main entrance, elevator detected near the lobby reception, no accessible toilet detected in the images, generate a clear and concise explanation of the facility's barrier-free status for wheelchair users in English.”
The output is a fully formed prompt sentence that embeds the structured barrier-free features and is ready for submission to the generative AI model.
Step 8:
The server transmits the prompt sentence to the generative AI model and receives a natural-language explanation.
The input is the generated prompt sentence and, optionally, references to representative images or thumbnails.
The server sends an API request to the generative AI model, specifying the prompt sentence and generation parameters such as output length and temperature.
The server receives the model's response and parses the returned text as a natural-language explanation describing the facility's barrier-free status.
The output is a natural-language explanation text associated with the corresponding structured barrier-free record.
Step 9:
The server stores and links the natural-language explanation with the structured barrier-free information.
The input is the explanation text returned by the generative AI model and the previously generated structured record.
The server writes the text into the database as part of the facility record and maintains references from the explanation to the underlying structured fields and source visual data identifiers.
The server updates indices to allow retrieval of both machine-readable features and human-readable descriptions for a given facility.
The output is an updated facility record that contains both structured barrier-free information and its corresponding natural-language explanation.
Step 10:
The terminal requests barrier-free information for a specific facility and receives the combined structured and natural-language data from the server.
The input is a user-initiated request on the terminal, identifying a target facility.
The terminal sends a query to the server; the server retrieves the relevant facility record, including the structured barrier-free fields and the explanation text, and returns them in a response.
The terminal parses the response, extracting the structured indicators and the explanatory text for presentation.
The output is a data set available on the terminal containing both symbolic indicators and narrative description of the facility's barrier-free status.
Step 11:
The terminal displays the barrier-free information to the user and collects feedback.
The input is the structured indicators and natural-language explanation supplied by the server.
The terminal renders icons and labels—for example, “Elevator: Yes,” “Step at entrance: Yes,” “Accessible toilet: Not confirmed”—along with the full explanation sentence or paragraph.
The user reads the displayed information and, if desired, inputs feedback such as corrections, comments, or ratings via buttons, text fields, or selection controls on the user interface.
The output is user feedback data captured on the terminal and prepared for transmission to the server.
Step 12:
The server receives user feedback and generates improvement proposal information based on the feedback and barrier-free features.
The input is the user feedback data sent from the terminal and the structured barrier-free record stored in the database.
The server analyzes the feedback in combination with the barrier-free fields, applies rule-based criteria and, optionally, a trained model to determine recommended changes to structural or equipment elements of the facility.
The server generates improvement proposal information, such as recommendations to install ramps, widen doorways, add grab bars, or revise signage, and stores these proposals in association with the facility record.
The output is a set of structured and textual improvement proposals that can be displayed to users or provided to facility operators via information providing media.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional techniques for providing barrier-free information for facilities largely rely on manual surveys, manual annotation of images, and static description pages. These approaches suffer from several technical limitations in terms of how computing resources are used to acquire, process, and deliver accessibility information to end users.
First, conventional systems typically handle facility images or videos either as simple media files for viewing or as inputs to narrowly focused recognition algorithms. Such systems do not integrate a unified processing pipeline that combines deterministic image processing, learned inference, and natural-language generation. As a result, server-side processing cannot efficiently transform large volumes of raw visual data into structured, machine-readable barrier-free information and human-readable explanatory text, and thus cannot scale to a large number of facilities.
Second, existing systems that incorporate machine learning models often treat model outputs as final results and simply store classification labels or detection boxes. These systems lack a mechanism for constructing rich, context-aware prompt sentences that feed both low-level features and high-level inferences into a generative artificial intelligence model. Without such structured prompt construction, the server cannot effectively utilize generative models to produce coherent and user-tailored natural-language descriptions of barrier-free conditions, leading to suboptimal use of computational resources and limited expressiveness of the output.
Third, conventional server-client architectures for accessibility information frequently present static or manually authored content to the user interface, without any adaptive feedback loop. User feedback, when collected, is often stored in an unstructured manner and is not integrated into a technical process that updates or refines the underlying barrier-free information or improvement suggestions. Consequently, the system is unable to technically improve its internal data representations and generated content over time based on user interactions, which limits the accuracy and reliability of information delivered to terminal devices.
Fourth, existing systems do not adequately address the problem of efficiently structuring, indexing, and serving both machine-generated barrier-free data and generated natural-language explanations as a coherent data object. This leads to fragmentation across databases or services and results in increased latency and complexity when terminal devices request facility information. There is a need for an integrated server-side data model and processing flow that associates visual inputs, extracted features, inferred barrier-free attributes, generative explanations, and feedback-based improvement plans under unified facility identifiers.
Accordingly, there is a need for an improved computer-implemented system and method that (i) receives and preprocesses facility visual data, (ii) extracts barrier-free related features using image processing, (iii) generates structured barrier-free information using machine learning inference, (iv) constructs and submits prompt sentences and associated data to a generative artificial intelligence model to produce natural-language explanation information, (v) stores these results as structured data associated with facility identification information, and (vi) incorporates user feedback to automatically generate and update improvement plans. Such a system should improve the technical functioning of the server by optimizing the way visual data, model inference results, generative outputs, and user feedback are integrated, stored, and served to terminal devices in a scalable, automated manner.

The specific processing by the specific processing unit 290 of the data processing device 12 in Application Example 1 is realized by the following means.

The present invention provides a server comprising a processor and a storage device, the processor being configured to receive visual data of a facility and store the visual data in the storage device; to apply image processing using a general-purpose image processing program or a general-purpose image processing library to extract feature values related to barrier-free structures from the visual data; to execute inference processing using a general-purpose machine learning framework on the feature values or the visual data to generate barrier-free information including at least one of presence or absence of level differences, installation status of lifting equipment, and accessibility status of sanitary equipment; to construct a prompt sentence for input to a generative artificial intelligence model on the basis of the generated barrier-free information and metadata including the feature values, and to input the prompt sentence and at least one of the visual data and the barrier-free information into the generative artificial intelligence model to cause the generative artificial intelligence model to generate explanation information in natural language; to store the barrier-free information and the explanation information as structured data in the storage device in association with facility identification information, and to provide the structured data to a terminal device in response to an acquisition request from the terminal device; to cause the terminal device to display the barrier-free information and the explanation information via a user interface of the terminal device, and to receive evaluation information or comment information from a user as feedback information; and to analyze the feedback information by using at least one of machine learning processing and rule-based processing, to generate, on the basis of the feedback information and the barrier-free information, an improvement plan for barrier-free measures in the facility including at least one of elimination of level differences, increase of lifting equipment, and renovation of sanitary equipment, and to store the improvement plan as part of the structured data in the storage device. This enables an integrated and technically improved server-side processing pipeline that automatically transforms large-scale facility visual data into structured barrier-free information and adaptive natural-language explanations, maintains these results in an associated data structure indexed by facility identification, and iteratively refines barrier-free improvement plans based on analyzed user feedback, thereby enhancing the efficiency, scalability, and reliability of the computer system that provides barrier-free information to terminal devices.

The term “visual data” refers to electronic data representing visual information of a facility, including at least one of still image data and moving image data that depict interior or exterior scenes of the facility.
The term “facility” refers to a physical site used for public or commercial purposes, including at least one of a building, a complex, or a space in which users can enter and use services or equipment.
The term “storage device” refers to a hardware component or subsystem configured to store electronic data, including at least one of a semiconductor memory, a magnetic storage medium, or an optical storage medium.
The term “image processing” refers to computational operations performed on visual data to analyze or transform the visual data, including at least one of resizing, filtering, edge detection, contour detection, or region extraction.
The term “general-purpose image processing program” refers to software executed by a processor that implements image processing functions not limited to a specific facility or dataset and that can be used for various types of image analysis.
The term “general-purpose image processing library” refers to a collection of software modules that provide reusable image processing functions and application programming interfaces enabling a processor to perform operations on visual data for a variety of applications.
The term “feature values” refers to numerical or symbolic data derived from visual data that represent characteristics of objects or regions, including at least one of shapes, edges, contours, coordinates, colors, or texture descriptors.
The term “barrier-free structures” refers to physical structures or arrangements in a facility that affect accessibility for users with mobility or other limitations, including at least one of level differences, ramps, lifting equipment, and sanitary equipment.
The term “general-purpose machine learning framework” refers to a software framework that provides functions for constructing, training, and executing machine learning models for a variety of tasks and datasets, and is not limited to a specific application domain.
The term “inference processing” refers to a computational procedure in which a trained machine learning model receives input data and produces output data such as classifications, predictions, or detected attributes without further model training.
The term “barrier-free information” refers to structured data that indicates accessibility-related conditions of a facility, including at least one of presence or absence of level differences, installation status of lifting equipment, and accessibility status of sanitary equipment.
The term “level difference” refers to a vertical discontinuity between adjacent surfaces in a facility, including at least one of steps, thresholds, and changes in floor height that may affect passage by users.
The term “lifting equipment” refers to mechanical equipment for vertical transportation of users or goods within a facility, including at least one of elevators, platform lifts, and stair lifts.
The term “sanitary equipment” refers to equipment and spaces in a facility intended for personal hygiene, including at least one of toilets, washbasins, and related fixtures.
The term “accessibility status” refers to an attribute indicating whether a structure or equipment can be used by users with mobility or other limitations, including at least one of wheelchair accessibility, presence of handrails, and presence of sufficient maneuvering space.
The term “prompt sentence” refers to a text string that provides instructions or context to a generative artificial intelligence model, including at least one of questions, commands, or descriptions specifying a desired output related to barrier-free information.
The term “generative artificial intelligence model” refers to a machine learning model configured to generate data, including at least natural-language text, based on input data such as prompt sentences, feature values, or visual data.
The term “explanation information” refers to natural-language text generated on the basis of barrier-free information and other data, describing accessibility-related conditions of a facility in a form understandable by users.
The term “structured data” refers to data arranged in a predefined format or schema, including at least one of records, fields, and key-value pairs, that allows efficient storage, retrieval, and processing by a computer system.
The term “facility identification information” refers to data that uniquely or specifically identifies a facility within the system, including at least one of identifiers, names, and location information.
The term “terminal device” refers to an electronic device operated by a user to access information from the server, including at least one of a smartphone, a tablet device, and a personal computer.
The term “user interface” refers to a combination of hardware and software components that allow interaction between a user and a terminal device or server, including at least one of display screens, input controls, and graphical user interface elements.
The term “evaluation information” refers to data representing a user's assessment of barrier-free information or a facility, including at least one of rating values, selection of evaluation items, and structured feedback categories.
The term “comment information” refers to text or other user-generated content that describes the user's opinion, experience, or requests regarding the barrier-free conditions of a facility.
The term “feedback information” refers to information received from a user in response to displayed barrier-free information or explanations, including at least evaluation information and comment information.
The term “machine learning processing” refers to computational operations that apply a machine learning model to input data to derive outputs, including at least one of classification, regression, clustering, and recommendation.
The term “rule-based processing” refers to computational processing that applies predetermined logical conditions or rules to input data to derive outputs, without modifying the rules during operation.
The term “improvement plan” refers to information indicating proposed changes to structures, equipment, or arrangements in a facility to enhance accessibility, including at least one of modifications to level differences, additions or changes to lifting equipment, and modifications to sanitary equipment.
The term “elimination of level differences” refers to measures taken to reduce or remove vertical discontinuities in a facility, including at least one of adding ramps, adjusting floor heights, and installing slope structures.
The term “increase of lifting equipment” refers to measures taken to add or upgrade lifting equipment in a facility, including at least one of installing additional elevators and installing additional lifts.
The term “renovation of sanitary equipment” refers to measures taken to modify sanitary equipment or related spaces in a facility, including at least one of enlarging toilet spaces, adding handrails, and installing accessible fixtures.
The term “acquisition request” refers to a request message transmitted from a terminal device to the server for obtaining structured data related to barrier-free information or explanation information for a facility.

In one embodiment, a server implements the claimed system by executing a barrier-free information processing program on one or more processors. The server includes at least one central processing unit (CPU), an optional graphics processing unit (GPU), a main memory, a non-volatile storage device, and a network interface. The server runs a general-purpose operating system, such as a server-class operating system, and hosts application software implemented, for example, using a web application framework. The server is connected via a network, such as the Internet or a local area network, to one or more terminal devices operated by users. Each terminal includes at least one processor, a memory, a display unit, an input unit such as a touch panel, and a communication module, and executes an application program for presenting barrier-free information.
The server receives visual data of facilities from external data sources, such as content management systems or facility operator devices. The visual data includes still images and videos of facility interiors and exteriors. The server stores the received visual data in a storage device, such as a solid-state drive or an object storage system. The server maintains, in a relational or document-oriented database, records that associate each visual data item with facility identification information, such as a facility identifier, a facility name, and location information.
The server applies image processing to the visual data by using a general-purpose image processing library, such as a library that implements edge detection, contour extraction, and region segmentation. The server, for example, resizes images to a predetermined resolution, converts color spaces, and normalizes pixel values to floating-point ranges. The server then performs edge detection, line detection, and contour detection to extract feature values that represent candidate shapes of steps, ramps, doors, elevators, and sanitary equipment signs. The server structures these feature values as arrays or matrices that include coordinates, bounding box sizes, orientation angles, and shape descriptors.
The server executes inference processing by using a general-purpose machine learning framework, such as a deep learning framework that supports tensor operations and neural network execution. In one example, the server loads a trained convolutional neural network model whose architecture includes multiple convolutional layers, pooling layers, batch normalization layers, and fully connected layers. The server configures the neural network with an object detection head, such as a region proposal module and classification and regression layers, to output, for each image, detected regions and associated labels and confidence scores.
The server provides the preprocessed images or the extracted feature values as input tensors to the neural network model and causes the framework to perform batched forward propagation. The server thereby generates, for each image, an output that includes class probabilities for categories such as “step,” “ramp,” “flat entrance,” “elevator,” and “accessible toilet,” as well as bounding box coordinates. During model training, the server uses a supervised learning method, such as stochastic gradient descent or an adaptive gradient method, and defines a loss function that combines classification loss and bounding box regression loss. The server performs backpropagation and weight updates based on the loss to minimize the difference between predicted labels and ground truth annotations. In deployment, the server executes only the forward inference path, but uses the trained weights obtained from the above-described learning procedure.
The server converts the raw outputs of the neural network into barrier-free information by applying non-maximum suppression to merge overlapping bounding boxes, thresholding to remove detections with low confidence scores, and rule-based aggregation to reconcile multiple detections across images associated with a single facility. The server, for example, calculates statistics over multiple images indicating the same entrance, and determines, on the basis of majority voting and spatial consistency, whether the entrance has a level difference or is flat. The server encodes this result in structured barrier-free information, including fields that indicate presence or absence of level differences, installation status of lifting equipment, and accessibility status of sanitary equipment for each relevant area of the facility.
The server constructs a prompt sentence for a generative AI model by using the barrier-free information and the feature values as metadata. The server employs a template-based approach in which a base text includes placeholders for detected attributes. The server, for example, generates a prompt sentence such as:
“Analyze the following facility conditions: the main entrance has no steps, an elevator is present near the central hall, and an accessible toilet is located on the second floor. Based on these conditions, generate a clear, concise natural language description of the barrier-free situation for users with limited mobility.”
In another example, the server generates a prompt sentence such as:
“From this facility image and the following detected attributes (entrance steps: none; elevator: present; accessible toilet: present on 2nd floor), generate barrier-free information in natural language, describing how easily a wheelchair user can enter and move inside the facility.”
The server can further create a more detailed prompt sentence that instructs the model to produce structured explanations:
“You are an accessibility analysis assistant. Using this facility image and the detection results (no steps at main entrance, elevator near north entrance, accessible toilet on each floor), describe the barrier-free conditions. Explicitly mention whether wheelchair users can enter without assistance, how they can move between floors, and where they can find accessible toilets.”
The server transmits the constructed prompt sentence and associated data, including either the original visual data or the derived barrier-free information, to a generative AI model executed locally or provided as a remote service. The generative AI model, in one example, is a sequence-to-sequence neural network or a transformer-based language model pre-trained on large-scale text data and optionally fine-tuned on accessibility-related corpora. The server encodes the prompt sentence into token sequences, performs attention-based decoding in the model, and obtains explanation information as a natural-language text sequence. When the generative AI model is a transformer, the server controls parameters such as maximum output length, temperature, and beam width to balance diversity and determinism of the generated text.
The server stores, in the storage device, the barrier-free information and the explanation information as structured data associated with facility identification information. The server may use a document format in which each facility record includes fields for visual data references, feature values, barrier-free attribute summaries, generated textual explanations, and improvement plans. By storing the barrier-free information and explanations in this structured manner, the server can respond to requests from terminal devices with minimal post-processing, which improves response time and reduces processing load.
The terminal periodically or on demand transmits an acquisition request to the server, including facility identification information or a search query. The server searches the structured data for a matching facility record and returns the barrier-free information and explanation information in a structured response. The terminal parses the response, maps the fields to user interface elements, and displays, on the display unit, both concise attribute indicators and the generated natural-language explanation. The terminal may display icons indicating, for example, the presence of a ramp or elevator, and textual sentences that explain how the user can navigate through the facility.
The user operates the terminal by entering a facility name or selecting a facility from a list.
The user reads the displayed barrier-free information and explanation information to understand whether the facility meets accessibility requirements. The user may also input feedback via rating controls or free-text comment fields. The terminal transmits this feedback information to the server.
The server receives the feedback information and stores it in association with the facility record. The server analyzes the feedback by using either a machine learning model or a rule-based module. In one embodiment, the server uses a text classification or sentiment analysis model implemented with the same or another machine learning framework to categorize comment information into topics such as “insufficient ramp,” “elevator congestion,” or “toilet space too narrow.” The server defines an objective function for feedback analysis, such as cross-entropy over feedback categories, and uses supervised learning to train the model with annotated feedback samples. Alternatively or additionally, the server uses rule-based processing, such as keyword matching or pattern rules, to extract specific improvement needs from textual feedback.
The server then generates an improvement plan based on both the barrier-free information and the feedback analysis results. The server, for instance, determines that repeated comments indicating difficulty at the main entrance, combined with barrier-free information showing a small but detectable level difference, justify a recommendation to eliminate the level difference or add a ramp. The server structures the improvement plan as data elements that specify recommended modifications to level differences, additional lifting equipment, or renovation of sanitary equipment. The server stores the improvement plan as part of the structured data for the facility, so that future terminal requests can retrieve not only current barrier-free conditions but also suggested improvements.
The described configuration improves computer technology in several ways. The server integrates deterministic image processing, feature extraction, machine learning inference, prompt-based generative modeling, and feedback-driven improvement generation into a unified data flow. By converting raw visual data into structured feature values and barrier-free information before invoking the generative AI model, the server reduces the amount of data that must be processed by the generative model and constrains the generation space, leading to faster processing and reduced computational load. This improves the efficiency of the server's use of processing resources, particularly when processing large volumes of facility visual data.
Moreover, the server's template-based construction of prompt sentences that include structured metadata enables the generative AI model to produce more accurate and consistent explanations. This design reduces the need for repeated trial-and-error prompts and minimizes redundant network calls, which in turn lowers communication overhead and latency. The explicit association of visual data, feature values, barrier-free attributes, generated explanations, and improvement plans within a single facility record allows the server to perform indexed retrieval and caching, improving data management and query performance compared to unstructured storage.
The use of specific neural network architectures and learning procedures also contributes to technical effects. The server trains the convolutional neural network with data augmentation techniques such as random cropping, rotation, brightness adjustment, and scaling to improve robustness to variations in lighting and camera angles. The server uses regularization techniques and optimizer configurations to stabilize training and improve generalization. As a result, the neural network achieves higher detection accuracy for barrier-free structures than simple threshold-based or manually engineered feature approaches. This increased accuracy directly reduces false positives and false negatives in barrier-free information, which is a measurable technical improvement over conventional systems that rely mainly on manual annotation or basic recognition algorithms.
The generative AI model processing is not a mere automation of human language generation. The server enforces a specific, non-conventional pipeline in which internal representations from deterministic and learned components are combined into constrained prompt sentences. This pipeline yields technical benefits, such as reduced variance in generated content, improved alignment with structured data, and easier post-processing. The server's analysis of user feedback using machine learning or rule-based modules further differentiates the system from simple manual review. The server applies consistent, machine-implemented criteria to large volumes of feedback and automatically updates improvement plans, which would not be feasible at scale with human-only processes.
The server, the terminal, and the user thus cooperate in a cycle: the server processes visual data and feedback into structured barrier-free information and improvement plans; the terminal presents these results in an optimized user interface; and the user provides further feedback. This closed loop improves the completeness and accuracy of barrier-free data over time and leverages computer-specific mechanisms, such as learned feature representations, high-dimensional optimization, and indexed structured storage, rather than merely digitizing a manual workflow.
In alternative embodiments, the server can employ different neural network architectures, such as recurrent networks or transformer-based visual encoders, instead of or in addition to convolutional networks. The server can also implement the generative AI model as a locally deployed model or as a distributed model across multiple servers. The image processing algorithms may vary, for example by using different feature descriptors, segmentation methods, or multi-scale analysis, while still extracting feature values related to barrier-free structures. The machine learning framework can be any general-purpose framework capable of tensor computation and model execution. The terminal devices can include wearable devices or in-vehicle systems as long as they can send acquisition requests and display barrier-free information and explanation information. These variations remain within the scope of the described system, as they preserve the essential configuration in which the server processes visual data and feedback through a specific combination of image processing, machine learning inference, prompt-based generative modeling, and structured data management to realize improved technical behavior of the computer system.

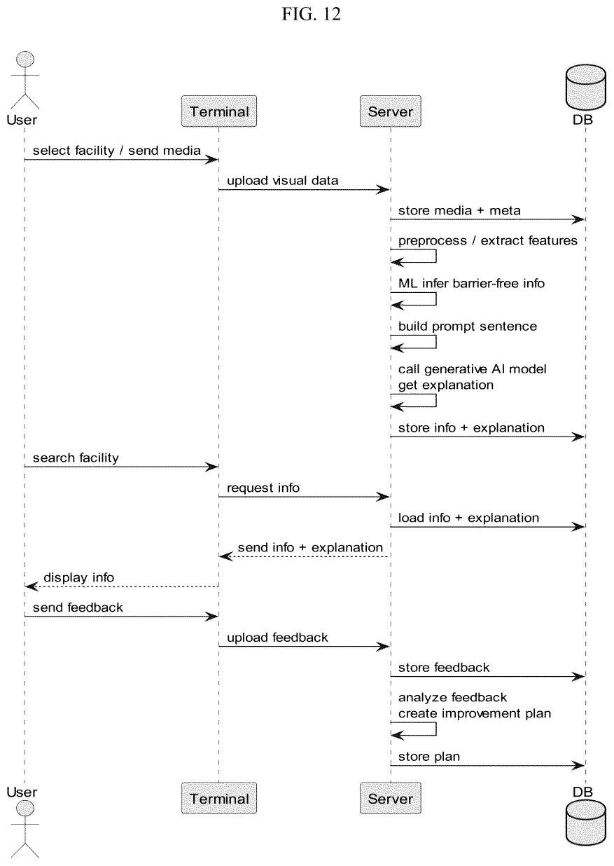

The following describes the processing flow using FIG. 12.
Step 1:
The server receives visual data of a facility from an external source via a network interface.
The input is raw image files or video files together with facility identification information.
The server stores the files in a storage device and registers metadata, including file paths and facility identifiers, in a database. The server thereby converts incoming byte streams into persisted media objects and structured metadata records as the output.
Step 2:
The server preprocesses the stored visual data by using an image processing library. The input is the raw image or decoded video frame. The server resizes each image to a fixed resolution, converts color space (for example, from BGR to RGB), normalizes pixel values, and, for videos, extracts frames at predetermined time intervals. The server outputs normalized image arrays suitable for subsequent feature extraction and inference, along with updated metadata that records preprocessing parameters.
Step 3:
The server extracts low-level visual features related to barrier-free structures. The input is the normalized image arrays. The server applies edge detection, contour extraction, and region-of-interest detection to highlight potential steps, ramps, elevators, and sanitary symbols. The server computes feature values such as bounding box coordinates, contour shapes, line orientations, and region textures. The output is a structured feature set for each image, represented as numerical vectors or matrices indexed by feature type and location.
Step 4:
The server performs machine learning inference to detect barrier-free elements. The input is either the preprocessed images or the extracted feature sets. The server loads a trained neural network model from the machine learning framework and executes forward propagation on batched inputs. The server computes class probabilities and bounding box regressions for categories including steps, ramps, lifting equipment, and sanitary equipment. The output is a set of detection results for each image, including labels, confidence scores, and bounding box coordinates.
Step 5:
The server post-processes the detection results to generate barrier-free information. The input is the raw detection outputs from the neural network. The server applies thresholding to discard low-confidence detections, performs non-maximum suppression to merge overlapping bounding boxes, and aggregates detections across multiple images of the same area. The server then derives high-level attributes such as “no level difference at main entrance,” “elevator present near central hall,” and “accessible toilet on second floor.” The output is structured barrier-free information encoded in fields associated with facility identifiers.
Step 6:
The server constructs a prompt sentence for a generative AI model by using the barrier-free information and feature metadata. The input is the structured barrier-free attributes and selected feature values. The server fills a text template with detected conditions, concatenates explanatory clauses, and adds explicit instructions for the generative AI model. The server thereby produces a prompt sentence such as “Analyze the following facility conditions: . . . generate a natural language description of the barrier-free situation.” The output is a finalized prompt sentence string that encodes both factual data and generation instructions.
Step 7:
The server invokes a generative AI model to generate explanation information in natural language. The input is the prompt sentence and at least one of the original visual data or the structured barrier-free information. The server tokenizes the prompt, sends tokens and optional auxiliary data to the generative AI model, and controls decoding parameters such as maximum length and sampling strategy. The generative AI model returns a sequence of tokens, which the server detokenizes into human-readable text. The output is explanation information that describes the facility's barrier-free conditions in natural language.
Step 8:
The server stores the barrier-free information and the generated explanation information as structured data. The input is the structured barrier-free attributes and the explanation text associated with a facility identifier. The server creates or updates a facility record in the storage device, writing fields for visual data references, feature values, barrier-free attributes, explanation text, and timestamps. The server indexes these records by facility identification information to support efficient retrieval. The output is an updated persistent data structure that binds all related information for each facility.
Step 9:
The terminal sends an acquisition request for barrier-free information to the server. The input is a user-initiated query, such as a facility name or identifier entered in the application interface. The terminal packages the query into a request message, attaches user settings such as language preference, and transmits the request over the network. The output is a formatted request that the server can parse to identify the target facility and response parameters.
Step 10:
The server responds to the acquisition request by retrieving and returning structured data. The input is the acquisition request containing facility identification information. The server queries the storage device for the corresponding facility record, extracts the barrier-free information and explanation text, and serializes these fields into a response format. The server then transmits the serialized data back to the terminal. The output is a response message that encapsulates the facility's barrier-free attributes and explanation information.
Step 11:
The terminal presents the barrier-free information and explanation information to the user.
The input is the response message received from the server. The terminal parses the structured data, maps data fields to UI components, and renders icons, text labels, and paragraphs on the display. The terminal may, for example, show a list of attributes (presence of ramps, elevators, accessible toilets) and the natural-language explanation in a detail view.
The output is a rendered user interface that conveys the barrier-free status of the facility.
Step 12:
The user reviews the displayed information and provides feedback. The input is the presented barrier-free attributes and explanations. The user evaluates the accuracy and usefulness of the information, interacts with UI elements such as rating controls or comment text boxes, and enters evaluation values or textual comments. The output is user-generated feedback data captured by the terminal.
Step 13:
The terminal transmits the feedback information to the server. The input is the user's evaluation values and comment text associated with a facility identifier. The terminal packages this data into a feedback message and sends it over the network to the server. The output is a formatted feedback request that the server can store and analyze.
Step 14:
The server analyzes the feedback information to derive improvement needs. The input is the feedback message containing evaluation values and comment text, together with the existing barrier-free information for the facility. The server applies either a machine learning model, such as a text classifier or sentiment analyzer, or a rule-based module that detects keywords and patterns indicating problems or suggestions. The server computes scores or categories for issues like “entrance step problematic” or “toilet space insufficient.” The output is an intermediate representation of improvement needs expressed as structured indicators.
Step 15:
The server generates an improvement plan for the facility based on the analyzed feedback and existing barrier-free information. The input is the structured improvement indicators and the current barrier-free attributes. The server applies rule logic or optimization criteria to determine which structural or equipment changes would best address the identified issues, such as eliminating level differences, adding lifting equipment, or renovating sanitary equipment. The server encodes these recommendations as an improvement plan, attaches it to the facility record, and stores the updated record in the storage device. The output is a persistent improvement plan that can be referenced in future processing or displayed to authorized parties.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional systems for publishing accessibility or barrier-free information about facilities typically rely on static content authoring and manual page design. In many implementations, a human operator must collect raw facility data, interpret the data, write narrative explanations, and hand-craft web pages or other presentation formats. This workflow consumes significant time and is highly dependent on individual skills, which leads to inconsistent quality of explanations and limited scalability across many facilities. Furthermore, conventional systems often treat accessibility description as a simple content-management problem rather than a computing problem. They do not fully exploit structured data representations, automated prompt generation, or generative artificial intelligence models. As a result, these systems fail to optimize the end-to-end data flow from user input through machine processing to user-facing presentation. In particular, existing architectures exhibit several technical shortcomings: (i) they do not systematically transform user-submitted facility attributes into normalized structured data; (ii) they do not automatically synthesize prompt sentences that express higher-level concepts suitable for input to a generative artificial intelligence model; (iii) they do not integrate the model output into a standardized document structure for automatic markup generation; and (iv) they do not provide a closed feedback loop in which user feedback dynamically updates the underlying structured data and regenerates both prompts and presentation data.
These limitations result in technical inefficiencies within the computing environment. For example, servers must perform repeated manual or ad hoc transformations when content is updated, which increases processing latency and resource consumption. The absence of a structured pipeline from attribute acquisition, through prompt sentence generation, through markup generation, and back through feedback-driven regeneration, prevents the system from automatically optimizing the quality and timeliness of barrier-free information. In addition, without a standardized markup structure and automated styling pipeline, rendering components on user terminals cannot reliably present consistent and accessible interfaces, leading to suboptimal human-computer interaction and increased client-side processing overhead.
Accordingly, there is a need for a system and method that improve the operation of computing devices by introducing a server-side architecture that (a) acquires and normalizes facility attribute information as structured data, (b) automatically generates prompt sentences at an appropriate abstraction level for a generative artificial intelligence model, (c) uses the model output in combination with structured data to dynamically generate standardized markup language data and visual presentation data, and (d) employs user feedback as machine-processable input to automatically update the structured data and regenerate both prompts and presentation data. Such an architecture would reduce manual intervention, improve consistency and accuracy of accessibility information, and enhance the overall efficiency and technical robustness of the underlying computer system.

The specific processing by the specific processing unit 290 of the data processing device 12 in Example 2 is realized by the following means.

The present invention provides a server comprising a processor configured to acquire attribute information related to a facility from a user terminal and store the attribute information as structured data, generate a prompt sentence based on the structured data to instruct a generative artificial intelligence model to generate barrier-free information, input the prompt sentence to the generative artificial intelligence model and obtain a natural-language explanation including the barrier-free information from the generative artificial intelligence model, dynamically generate markup language data having a standardized document structure by template processing based on the barrier-free information and the natural-language explanation, add decorative information for visual representation to the markup language data to generate information display data and distribute the information display data to an information-providing medium, and update at least one of the structured data and the barrier-free information based on user feedback acquired via the information-providing medium and regenerate the prompt sentence and the information display data in accordance with the update. This enables the computing system to automatically convert user-submitted facility attributes into normalized machine-readable data, to efficiently drive a generative artificial intelligence model using systematically constructed prompt sentences, to generate standardized markup and presentation data with reduced server-side and client-side processing overhead, and to maintain up-to-date and consistent barrier-free information through a closed feedback loop that improves the technical performance and scalability of the overall computer architecture.

The term “processor” refers to a hardware computation unit, such as a central processing unit or a dedicated processing circuit, configured to execute instructions and perform data processing operations according to one or more programs.
The term “user terminal” refers to an information processing device operated by a user, such as a workstation, a portable computer, a handheld device, or a communication terminal, configured to transmit data to and receive data from a server over a communication network. The term “facility” refers to a physical environment, building, or installation, including any associated structures and spaces, for which accessibility or barrier-free information is to be generated and provided.
The term “attribute information” refers to data items representing properties or characteristics of a facility, including but not limited to the presence, absence, or configuration of equipment, spaces, or services relevant to accessibility or barrier-free use.
The term “structured data” refers to data that is organized according to a predefined schema or format, such as a key-value set, a record structure, or a tabular representation, enabling deterministic parsing, validation, and programmatic manipulation by a computing device.
The term “barrier-free information” refers to accessibility-related information that indicates how easily a facility can be used by individuals with physical, sensory, or cognitive limitations, including the availability and quality of accessibility-enhancing features.
The term “generative artificial intelligence model” refers to a machine-implemented model, such as a neural network-based language model, configured to generate output data including natural-language text in response to an input sequence such as a prompt sentence.
The term “prompt sentence” refers to an input sequence of symbols, including textual content, provided to a generative artificial intelligence model in order to specify a generation task and influence the characteristics of output generated by the generative artificial intelligence model.
The term “natural-language explanation” refers to text data expressed in a human language, generated automatically by a computing device, and configured to explain or describe barrier-free information in a form comprehensible to human users.
The term “markup language data” refers to electronically stored data expressed in a structured document description language that uses tags or similar constructs to denote elements, structure, and semantics of a document for machine interpretation and rendering.
The term “standardized document structure” refers to a pre-defined arrangement of document elements, sections, and relationships in markup language data, enabling consistent generation, parsing, and rendering of documents across multiple instances and devices.
The term “template processing” refers to a procedure in which a computing device combines a template including placeholders with structured data values to generate a completed document or data instance in accordance with a predefined format.
The term “decorative information” refers to presentation-related data, including style attributes, layout parameters, and visual design elements, used to control how content is rendered to a user without changing the underlying semantic content.
The term “information display data” refers to data generated for presentation to a user, including markup language data combined with decorative information, which is configured to be rendered by a display device or a user interface component.
The term “information-providing medium” refers to a platform or channel, including but not limited to a network-accessible server, a display apparatus, or a storage medium, through which information display data is made available to one or more user terminals.
The term “user feedback” refers to information provided by a user in response to displayed content, including evaluations, corrections, confirmations, or requests, which is acquired by a computing device and used as input to further processing.
The term “higher-level concepts” refers to abstracted or generalized representations of facility attributes that group or summarize lower-level data items into broader categories to facilitate processing by a generative artificial intelligence model.
The term “set of attributes” refers to a collection of multiple attribute elements, each representing a particular property or characteristic of a facility, which are processed together as a group by a computing device.
The term “features of the facility” refers to identifiable aspects or elements of a facility, extracted from attribute information or structured data, that represent functional or structural characteristics relevant to accessibility or barrier-free assessment.
The term “improvement proposal” refers to information generated by a computing device that describes one or more recommended changes to a facility, its equipment, or its operations, in order to enhance barrier-free or accessibility characteristics.
The term “closed feedback loop” refers to a processing configuration in which user feedback is re-introduced into the system as input data, causing updates to structured data and regenerated outputs, thereby iteratively improving the system's behavior or results.

In one embodiment, the system includes a server, one or more terminals, and a communication network connecting the server and the terminals. The server includes at least one processor, a main memory, a persistent storage device, and a network interface controller. The terminal includes a processor, a display device, an input device, a memory, and a communication unit. The server executes one or more software components including an operating system, a web application framework, a template engine, a data storage subsystem, and a generative AI client module. The terminal executes a web browser or an equivalent user interface program.
The server uses a hardware platform such as a general-purpose computing device equipped with a central processing unit, a volatile memory, a non-volatile storage device, and a network interface. The server runs an operating system such as a generic server operating system, and a web application framework such as a generic application framework implementing request routing and response generation. The server further uses a template engine such as a generic template engine to generate markup language data, and uses a database management system such as a relational database system to store structured data. The server may also use a secure communication library, a logging library, and a file transfer library.
The terminal uses a hardware platform such as a portable information processing device, a desktop information processing device, or a panel-type display device including a pointing input interface. The terminal runs a web browser implementing a layout engine such as a generic rendering engine and a script execution engine such as a generic script engine. The terminal presents a graphical user interface that includes input fields, buttons, and visual components that allow a user to enter facility attribute information and to view accessibility information generated by the server.
The server stores, in the persistent storage device, a program that causes the processor to perform acquisition, normalization, prompt generation, model interaction, markup generation, styling, distribution, and feedback processing. The server loads the program into the main memory and executes it so that the server performs data processing operations on attribute information related to facilities.
The server receives attribute information related to a facility from a terminal. The terminal displays, on a screen, a form generated by the server. The user uses the terminal to select or enter attribute values such as “elevator: available,” “wheelchair-accessible restroom: not available,” “entrance: step-free,” and “disabled parking: available.” The terminal sends the attribute information as structured messages over a network to the server. The server receives the messages and converts the attribute information into structured data. The server uses data structures such as key-value collections, record objects, and relational tables to store the attribute information in a normalized format. The server uses a data access module to write the structured data to a database.
The server performs a normalization process on the structured data. The server converts variant user expressions into canonical values. For example, the server converts “yes,” “available,” “exists,” and “true” into a unified positive state, and converts “no,” “not available,” and “false” into a unified negative state. The server groups related attributes into higher-level concepts. For example, the server groups “elevator,” “ramp,” and “step-free entrance” into a higher-level concept representing “vertical and entrance mobility support,” and groups “wheelchair-accessible restroom” and “handrails” into a higher-level concept representing “sanitary accessibility support.” The server represents these higher-level concepts in structured data fields so that the server can generate prompt sentences that express both low-level and high-level properties. This structured representation enables deterministic parsing, indexing, and retrieval, and reduces redundancy in the storage subsystem.
The server generates a prompt sentence for a generative AI model based on the normalized structured data and the higher-level concepts. The server uses a prompt generation algorithm that assembles text segments according to a template and rule set. The server applies rules that determine which attributes and which higher-level concepts to include, an ordering of attributes, and a phrasing style. The server thus produces a prompt sentence such as:
“Based on the following facility barrier-free data, generate a clear and friendly description for a public website: elevator: available; wheelchair-accessible restroom: available; entrance: step-free; disabled parking: available.” or
“You are generating an accessibility description for a public website. Using this data: elevator: yes, wheelchair-accessible restroom: no, entrance: ramp, disabled parking: yes, write 3-5 simple sentences that clearly explain how accessible the facility is.” or
“Create an HTML snippet (inside a section element) that describes the barrier-free features of a facility. Use a heading for the title and a list for each feature. Data: elevator: available; wheelchair-accessible restroom: not available; entrance: step-free; disabled parking: available.”
The server uses a generative AI client module to send the prompt sentence to a generative AI model. The server can host the generative AI model locally or access the model via a remote AI service. In one embodiment, the server uses a neural network model of a transformer architecture. The transformer architecture includes a plurality of encoder-decoder layers or decoder-only layers, each layer comprising a multi-head self-attention mechanism, a feed-forward network, normalization layers, and residual connections. The server stores model parameters, such as weight matrices and bias vectors, in a model storage module. The model parameters are obtained by a prior training process.
In a training phase that may be performed on a separate computing system, a training server uses training data including pairs of input prompt sequences and target textual outputs. The training server tokenizes the inputs, embeds the tokens into high-dimensional vectors, and processes the vectors through the transformer layers. The training server computes an error value using a loss function such as cross-entropy between the predicted token distribution and the target token distribution. The training server updates the weight parameters using an optimization algorithm such as stochastic gradient descent, adaptive moment estimation, or a related method. The training server may use regularization techniques, dropout, and data augmentation methods, such as paraphrasing of descriptions and variation of attribute combinations, to improve generalization performance. The training server repeats these steps over multiple epochs until convergence. The trained parameters are then deployed to the generative AI model used by the server.
In an inference phase, the server tokenizes the prompt sentence and converts it into embedding vectors. The generative AI model processes the embeddings through multiple attention layers. The attention mechanism computes attention scores for each token pair based on learned projections, and the model aggregates contextual information to generate output tokens. The model iteratively generates tokens until a termination condition is met.
The server decodes the tokens into text and obtains a natural-language explanation that describes the barrier-free characteristics of the facility.
The server does not merely replace human text authorship but uses the structured higher-level attribute representation and the transformer architecture to exploit patterns in accessibility descriptions that would be difficult to capture with simple rules. The server uses the generative AI model to synthesize coherent explanations that incorporate multiple interacting facility attributes. This synthesis reduces the number of separate database queries and rule evaluations that the server would otherwise need to perform. As a result, the server improves processing speed and reduces CPU load compared with a system that generates text solely through manually coded template combinations.
The server combines the natural-language explanation with the structured data to generate markup language data. The server uses a template engine to insert textual segments and attribute values into a standardized document structure. The standardized structure includes a header section, one or more content sections, and an optional summary section. The server maps each attribute or attribute group to specific markup elements. For example, the server inserts a heading element for the overall title, paragraph elements for narrative descriptions, and list elements for enumerated accessibility features. The server enforces a consistent nesting order and attribute encoding, which allows clients to parse and render the documents efficiently.
The server then applies decorative information to the markup language data. The server attaches style information such as class identifiers, layout directives, and color and typography parameters. The server may reference external style sheets that are optimized for accessibility, such as high-contrast themes and large text options. By centralizing the decorative information in style sheets and associating them with standardized structural elements, the server reduces duplication and enables incremental updates of the visual presentation without regenerating the entire document. This architecture reduces communication load because the server can cache and reuse style resources across multiple documents.
The server generates information display data that integrates the markup language data and the decorative information. The server distributes the information display data to an information-providing medium such as a web server, a signage controller, or a content distribution node. The server uses optimized transfer protocols and caching directives so that repeated access by terminals can be served quickly. The server may further compress the markup and style resources to reduce bandwidth.
The terminal receives the information display data from the information-providing medium. The terminal parses the markup language and the decorative information. The terminal constructs a document object structure in the browser engine and renders the structure on the display. Because the markup language data follows a standardized structure and uses consistent classes and tags, the parsing and layout operations on the terminal are simpler and more predictable, which reduces rendering time and memory usage. The user views the barrier-free information in a clear and consistent layout with headings, grouped sections, and icons.
The user interacts with the displayed content using the terminal to provide user feedback. The terminal transmits feedback information back to the server. The server acquires the user feedback and stores it as structured data. The server may classify feedback by type, such as error reports, confirmations, and suggestions. The server uses the feedback to update the structured data or the barrier-free information. For example, the user may indicate that an elevator has been newly installed or that a restroom has been renovated to become wheelchair-accessible. The server updates the corresponding attribute values and higher-level concepts.
The server also uses user feedback as input to another generative AI interaction. The server generates a prompt sentence that instructs the generative AI model to produce an improvement proposal. For example, the server constructs a prompt such as:
“Using the following user feedback on the current accessibility of the facility, generate a concrete improvement proposal that promotes barrier-free adaptation: feedback: ‘The entrance has stairs and no ramp; the restroom is narrow for wheelchairs.’”
The server sends this prompt sentence to the generative AI model. The generative AI model processes the prompt and generates text that suggests specific modifications, such as adding a ramp with a specified gradient or widening a passage to meet certain accessibility standards.
The server incorporates the improvement proposal into the information display data. For example, the server may render an additional section labeled “Recommended Improvements” on an administrative interface or facility management dashboard. This integration allows facility operators to view both current accessibility status and automatically generated improvement suggestions in a unified interface.
The server, by maintaining a closed feedback loop, repeatedly updates the structured data, regenerates prompt sentences, obtains updated descriptions and proposals from the generative AI model, and regenerates markup and information display data. This loop creates a dynamic and self-correcting system. The explicit structured representation and standardized markup enable efficient comparison of current and prior states, support differential updates, and reduce storage and transmission costs when only changed portions need to be distributed. The system improves computer technology in several ways. First, the server reduces processing overhead and latency by using structured data normalization and higher-level concept grouping, which lowers the complexity of later operations such as prompt generation and template rendering. Second, the server uses a transformer-based generative AI model that can combine many attributes and constraints in a single inference pass, avoiding multiple rule-based passes and manual template expansions. Third, the standardized document structure reduces parsing complexity on the terminal side, leading to faster rendering and decreased memory usage. Fourth, the feedback-driven regeneration mechanism allows the server to perform incremental updates rather than full reconstructions of content, which decreases network traffic and improves response time.
The server and the generative AI model jointly employ non-conventional processing steps compared with manual creation of descriptions. The server does not merely emulate human writing but actively restructures data into higher-level concepts, constructs specialized prompt sentences with defined patterns, and uses the neural attention mechanism inside the transformer architecture to capture dependencies between attributes that are not easily modeled by simple rules. The server leverages learned parameter distributions that encode correlations between facility attributes and natural-language expressions, and uses these correlations to synthesize text with fewer errors and inconsistencies than rule-based systems.

By doing so, the system achieves higher accuracy in describing combinations of accessibility features, and reduces misstatements that would arise from manually crafted fixed templates. In another embodiment, the server may use different types of generative AI models, such as a sequence-to-sequence recurrent network, a convolutional sequence model, or a hybrid architecture, provided that the model accepts prompt sentences and emits natural-language explanations. The server may further use additional modules for post-processing the generated text, such as grammar correction, readability adjustment, and domain-specific terminology normalization. These modules run on the server and operate on the generated output before integration into the markup. In a further embodiment, the server may execute parts of the inference computation on an accelerator such as a graphics processing unit or a specialized neural processing device. The server uses batch processing strategies to group multiple prompt sentences and perform inference in parallel. This strategy improves throughput and reduces per-request latency when many facilities need to be processed. The server may also cache model outputs for frequently occurring attribute patterns and reuse them when identical or similar structured data is encountered, thereby further reducing computation and improving response performance.
In yet another embodiment, the server may adapt the prompt generation rules based on logging and performance monitoring. The server analyzes how different prompt patterns affect model output length, response time, and user satisfaction metrics. The server updates the prompt templates and attribute ordering to achieve more concise prompts that still produce adequate descriptions, thereby reducing token count and inference time. The server thus dynamically tunes the interaction between structured data and the generative AI model to optimize computational efficiency.
In still another embodiment, the server can integrate additional sensor-derived or vision-derived attributes into the structured data by using separate feature extraction modules that process image data or location data. The server converts these low-level signals into higher-level accessibility attributes that are then passed through the same structured pipeline for prompt generation, model interaction, and markup generation. This extension further enhances the completeness of barrier-free information without increasing manual data entry. Through these embodiments, the server, the terminal, and the user cooperate to realize a system that not only automates the creation of accessibility content but also improves the internal operation of computing components. The specific data structures, higher-level concept grouping, transformer-based generative modeling, standardized markup generation, and closed feedback loop collectively provide technical effects such as faster processing, improved accuracy, reduced bandwidth usage, and more efficient use of server and client resources.

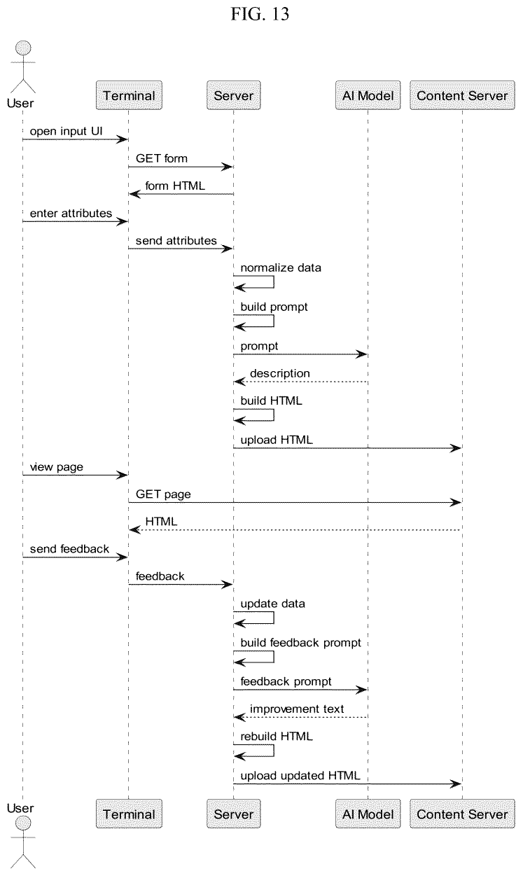

The following describes the processing flow using FIG. 13.
Step 1:
The user uses the terminal to open a user interface for facility input.
The terminal sends a request to the server to obtain an input form and receives markup language data and decorative information from the server as input.
The terminal renders the received markup language data on a display device and outputs a visible facility attribute input screen that includes fields for elevator availability, wheelchair-accessible restroom availability, entrance type, disabled parking, and other accessibility-related attributes.
Step 2:
The user uses the terminal to input facility attribute information into the displayed fields. The terminal receives the user's keystrokes, pointer selections, and touch operations as input events, and the terminal converts these input events into structured form values.
The terminal performs local validation on the form values, such as checking for required fields and allowable value ranges, and outputs a validated attribute dataset in a structured message format.
Step 3:
The terminal sends the validated attribute dataset to the server.
The terminal uses a communication unit to encapsulate the structured attribute dataset as a request payload and transmits the payload over a network to the server as input.
The terminal outputs a network message that includes the facility identifier and the normalized attribute values, and then waits for a response from the server.
Step 4:
The server receives the structured attribute dataset from the terminal.
The server uses a network interface controller to accept the network message as input and extracts the payload in a request handling module.
The server parses the payload into internal data structures such as key-value collections and outputs a first version of structured data representing the facility attributes.
Step 5
The server normalizes the structured data and generates higher-level concepts.
The server uses the first version of structured data as input and performs data processing operations such as value mapping, synonym resolution, and type conversion.
The server converts variant textual values into canonical states, groups related attributes into conceptual categories such as “mobility support” and “sanitary accessibility,” and outputs normalized structured data and a set of higher-level attribute concepts.
Step 6:
The server generates a prompt sentence for a generative AI model.
The server uses the normalized structured data and the higher-level attribute concepts as input to a prompt generation module.
The server applies ordering rules, inclusion rules, and template patterns to assemble a textual sequence and outputs a prompt sentence such as “Based on the following facility barrier-free data, generate a clear and friendly description for a public website: elevator: available; wheelchair-accessible restroom: available; entrance: step-free; disabled parking: available.”
Step 7:
The server sends the prompt sentence to the generative AI model and obtains a natural-language explanation.
The server uses the generated prompt sentence as input to a generative AI client module, which tokenizes the prompt sentence and forwards it to a generative AI model implemented by a transformer-based neural network.
The server receives a sequence of output tokens from the generative AI model, decodes the tokens into text, and outputs a natural-language explanation that describes the barrier-free characteristics of the facility.
Step 8:
The server integrates the natural-language explanation with the normalized structured data.
The server uses the normalized structured data and the natural-language explanation as input to a content integration module.
The server combines narrative text with structured attribute values, resolves any conflicts or omissions, and outputs a unified content representation that includes both machine-readable attributes and human-readable descriptions.
Step 9:
The server generates markup language data with a standardized document structure.
The server uses the unified content representation as input to a template engine.
The server populates predefined placeholders in a document template with attribute values and explanation text, assigns elements such as headings, paragraphs, and lists, and outputs markup language data that conforms to a standardized structural schema.
Step 10:
The server applies decorative information to the markup language data and creates information display data.
The server uses the standardized markup language data as input and associates style parameters such as layout, color, font, and icon classes from a style resource.
The server attaches references to style definitions or injects style attributes into the markup elements and outputs information display data that is ready for rendering on terminals and other display devices.
Step 11:
The server distributes the information display data to an information-providing medium.
The server uses the information display data as input to a distribution module that manages transfer to a hosting platform.
The server transmits the information display data to a content server, signage controller, or storage location, updates any index or linking structures, and outputs a hosted accessibility information resource that can be accessed by multiple terminals.
Step 12:
The terminal retrieves the hosted accessibility information from the information-providing medium.
The terminal uses a content request, including a resource locator, as input to a communication module and sends a retrieval request to the information-providing medium.
The terminal receives the information display data as a response, parses the markup and decorative information, and outputs a rendered accessibility page on the display for the user.
Step 13:
The user views the accessibility information and provides user feedback.
The user uses the terminal to read the rendered accessibility page as visual input and compares the displayed information with the actual status of the facility.
The user enters feedback such as corrections, confirmations, or improvement suggestions into a feedback interface on the terminal, and the terminal outputs a feedback message that encapsulates the user feedback in structured form.
Step 14:
The terminal sends the user feedback to the server.
The terminal uses the feedback message as input to the communication unit and transmits the message to the server over the network.
The terminal outputs a network request addressed to a feedback handling endpoint on the server and waits for acknowledgment.
Step 15:
The server receives and stores the user feedback as structured data.
The server uses the network interface controller to accept the feedback message as input and decodes the message into internal objects.
The server validates the feedback, associates it with the corresponding facility record, and outputs updated structured data that now includes both facility attributes and feedback entries.
Step 16:
The server updates the facility attributes and barrier-free information based on the user feedback.
The server uses the updated structured data and the feedback content as input to an update module that applies predefined update rules.
The server modifies attribute values, adds new entries, or marks outdated information according to rule-based logic, recalculates higher-level concepts if necessary, and outputs revised normalized structured data and revised barrier-free information.
Step 17:
The server generates a prompt sentence for an improvement proposal using the user feedback.
The server uses the user feedback and the revised structured data as input to the prompt generation module.
The server constructs a prompt sentence such as “Using the following user feedback on the current accessibility of the facility, generate a concrete improvement proposal that promotes barrier-free adaptation: feedback: ‘The entrance has stairs and no ramp; the restroom is narrow for wheelchairs,’” and outputs the improvement-oriented prompt sentence.
Step 18:
The server sends the improvement-oriented prompt sentence to the generative AI model and obtains an improvement proposal.
The server uses the improvement-oriented prompt sentence as input to the generative AI client module, which forwards the prompt to the generative AI model.
The server receives generated tokens from the generative AI model, decodes them into text describing recommended changes to the facility, and outputs an improvement proposal in natural-language form.
Step 19:
The server incorporates the improvement proposal into updated information display data.
The server uses the improvement proposal and the revised structured data as input to the content integration and template modules.
The server adds a dedicated section for recommendations, regenerates markup language data and decorative information for the updated content, and outputs new information display data that includes both current barrier-free status and suggested improvements.
Step 20:
The terminal retrieves and displays the updated accessibility information and improvement proposal.
The terminal uses a content retrieval request as input to the communication unit and acquires the updated information display data from the information-providing medium.
The terminal renders the updated markup and decorative information, displays both the current accessibility description and the improvement proposal to the user, and outputs an updated user interface that reflects the latest data processed by the server and the generative AI model.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional facility information systems typically present static accessibility information that is manually authored and infrequently updated. Such systems often rely on simple database lookups and template-based page generation, without deeply integrating automated recognition of facility features or advanced natural-language generation. As a result, these systems cannot effectively utilize large amounts of visual data (such as images and videos of facilities), and thus cannot maintain high-granularity, up-to-date barrier-free information.
Furthermore, known systems usually generate user interfaces according to fixed layouts that are not adapted to individual user behavior or emotional state. Even if accessibility content is technically available, users with different needs and levels of comprehension may experience difficulty in locating or understanding critical information, which leads to poor usability and low confidence when planning facility use. From a computing perspective, existing architectures do not close the loop between (i) data-driven facility analysis, (ii) content generation by a generative AI model, and (iii) user interaction and emotion feedback, so the user interface logic and content logic remain largely static and non-adaptive.
In addition, although generative AI models can produce natural-language explanations, conventional systems tend to send generic, manually written prompts that are not tightly coupled to machine-readable facility attributes. This leads to outputs that may be inconsistent, incomplete, or misaligned with the actual state of the facility, and requires additional manual curation. There is thus a technical problem in how to programmatically construct prompt sentences from structured attribute data and analytics results, and how to orchestrate a complete processing pipeline—from acquisition of visual information, through recognition and analytics, to structured prompt construction and selective use of generated output—in a way that is robust, repeatable, and efficient.
Moreover, existing server-side analytics rarely integrate fine-grained user feedback signals such as operation history and emotion estimation with facility-level barrier-free metrics. As a result, computing resources are not effectively used to iteratively refine the facility information presentation and to automatically generate facility-improvement proposals. The lack of an integrated architecture that programmatically uses user feedback, usage analytics, and emotion-state information to drive both UI adaptation and generative AI-based improvement planning represents a technical shortcoming in current computer-implemented facility information systems.
Accordingly, there is a need for a computer-implemented system that: (i) automatically analyzes facility visual and structural data to generate machine-readable barrier-free attribute data; (ii) programmatically constructs data-rich prompt sentences to control a generative AI model; (iii) dynamically generates and updates user-facing display data based on analytics and emotion information; and (iv) automatically produces facility-improvement proposals for managers, thereby improving the overall functioning of the computer system in collecting, processing, and presenting barrier-free information.

The specific processing by the specific processing unit 290 of the data processing device 12 in Application Example 2 is realized by the following means.

The present invention provides a server comprising a processor configured to acquire visual information and structural information related to a facility, to extract, by execution of image-processing algorithms and recognition models, equipment elements related to barrier-free use from the visual information, and to generate attribute data indicating a barrier-free state of the facility based on the extracted equipment elements and the structural information; to compute evaluation indicators derived from the attribute data and to construct, in a programmatic manner, a prompt sentence as an instruction text for a generative AI model by embedding the attribute data and the evaluation indicators into the prompt sentence, and to supply input data including the prompt sentence to the generative AI model so as to obtain from the generative AI model a natural-language explanatory text and a natural-language improvement-proposal text; to generate display data defining an information display screen that presents barrier-free information of the facility, by combining the explanatory text, the improvement-proposal text, and the attribute data into a structured layout, and to transmit the display data via a communication path to an information terminal so as to cause a user-facing display unit of the information terminal to output the information display screen; to receive, from the information terminal, operation-history information of a user and emotion-state information estimated by an emotion-recognition processing unit, to associate the operation-history information and the emotion-state information with components of the information display screen, to analyze the associated information, and to generate update data for updating at least one of a layout of the information display screen and explanatory content of the information display screen; and to obtain evaluation information from the user via the information terminal, to integrate the evaluation information and a result of the analysis with the attribute data and the evaluation indicators, to construct an additional prompt sentence as an additional instruction text for the generative AI model by embedding improvement content including at least one of additional arrangement positions of barrier-free equipment, improvement items of guidance information, and adjustment items of an information-presentation method, to input the additional prompt sentence to the generative AI model, and to obtain the improvement-proposal text from the generative AI model and output the improvement-proposal text as management-screen data or report data for a facility manager. This enables the computing system to automatically transform raw facility visual data into structured barrier-free attributes, to generate high-quality natural-language content under precise programmatic control of a generative AI model, and to iteratively adapt both user-facing interfaces and facility-improvement proposals based on integrated analytics of user interaction and emotion information, thereby improving the technical performance and usability of computer-implemented barrier-free information processing.

The term “facility” refers to a physical environment such as a building, structure, or site, including internal and external spaces, in which barrier-free usability for users is to be evaluated and improved.
The term “visual information” refers to image data or video data representing a scene of the facility, acquired by an imaging apparatus or similar sensing apparatus and suitable for processing by image-processing algorithms.
The term “structural information” refers to data representing physical characteristics of the facility, including layout, dimensions, positions of passages and rooms, and locations and types of installed equipment, obtained from sources such as digital drawings, databases, or sensing apparatuses.
The term “equipment element” refers to a physical component of the facility that affects barrier-free usability, including but not limited to stairs, level differences, lifting devices, inclined passages, entrances, doors, and sanitary installations.
The term “barrier-free state” refers to a condition of the facility in terms of accessibility and usability for persons with disabilities or reduced mobility, including presence, absence, and configuration of accessibility-related equipment elements.
The term “attribute data” refers to structured data items that quantitatively or qualitatively describe the barrier-free state of the facility, including flags, counts, positions, and metric values derived from recognition of equipment elements and structural information.
The term “evaluation indicator” refers to a numerical or categorical metric computed from the attribute data that represents a level of accessibility, conformity to a standard, or severity of a deficiency, for at least part of the facility.
The term “generative AI model” refers to an information-processing model trained by machine learning to generate natural-language text in response to input data, including an instruction text, and capable of outputting explanatory text or proposal text for barrier-free information.
The term “prompt sentence” refers to a text string or sequence of tokens that functions as an instruction text to the generative AI model, and that includes embedded attribute data, evaluation indicators, or improvement content to control generation of output text.
The term “explanatory text” refers to a natural-language text generated by the generative AI model that describes barrier-free conditions of the facility in human-readable form.
The term “improvement-proposal text” refers to a natural-language text generated by the generative AI model that includes suggested modifications or operational changes for enhancing the barrier-free state of the facility.
The term “display data” refers to data defining layout, content elements, and visual presentation of an information display screen, including text, symbols, and graphical elements, suitable for rendering by a display unit.
The term “information display screen” refers to a logical screen configuration presented on a display unit of an information terminal, including regions for barrier-free information, guidance, and related explanations.
The term “information terminal” refers to an electronic apparatus with a communication interface and a display unit, such as a portable terminal or a stationary terminal, capable of receiving display data and presenting the information display screen to a user.
The term “user-facing display unit” refers to a display apparatus of the information terminal, such as a liquid-crystal display or an organic-light-emitting display, that outputs visual content to a user.
The term “communication path” refers to a wired or wireless communication infrastructure, including networks and communication protocols, through which data are transmitted between the server and the information terminal.
The term “operation-history information” refers to data representing user interactions with the information display screen, including selections, scrolling operations, clicks, viewing durations, and navigation paths.
The term “emotion-state information” refers to data indicating an estimated emotional condition of the user, such as joy, confusion, anxiety, or satisfaction, derived by an emotion-recognition processing unit from sensor data.
The term “emotion-recognition processing unit” refers to a logical or physical processing component, implemented by software, hardware, or a combination thereof, that analyzes sensor data such as images, audio, or text to estimate the emotion-state information of the user.
The term “update data” refers to data specifying modifications to at least one of the layout or explanatory content of the information display screen, generated based on analysis of operation-history information and emotion-state information.
The term “evaluation information” refers to data explicitly provided by the user to indicate satisfaction level, assessment, or opinion regarding barrier-free information or facility usability, including rating values and free-form comments.
The term “improvement content” refers to structured information specifying candidate changes for enhancing the barrier-free state of the facility, including at least one of positions for additional barrier-free equipment, modifications to guidance information, and adjustments to information-presentation methods.
The term “management-screen data” refers to display data configured to present internal reports, analytics results, and improvement-proposal text to a managerial user on a management interface.
The term “report data” refers to data defining a document, including text and optional graphical elements, that summarizes barrier-free conditions, analytics results, and improvement-proposal text for provision to a facility manager or other stakeholder.
The term “facility manager” refers to a person or organizational role responsible for operation, maintenance, or planning of the facility, and for making decisions regarding barrier-free improvements based on the improvement-proposal text.
The term “image-processing algorithm” refers to a computational procedure applied to visual information to perform operations such as filtering, segmentation, feature extraction, or object detection.
The term “recognition model” refers to a trained computational model, including a machine-learning model, configured to identify or classify equipment elements or other features from visual information.
The term “trained recognition model” refers to a recognition model that has been trained on example data to detect facility components such as level differences, lifting devices, inclined passages, entrances, and sanitary installations.
The term “information-presentation method” refers to a manner of organizing, prioritizing, and visually representing information on the information display screen, including arrangement, emphasis, ordering, and styling of content elements.

In one embodiment, a server executes a computer program to implement the claimed system. The server includes at least one processor, a main memory, a non-volatile storage device, and a network interface. The processor executes software modules stored in the non-volatile storage device and loaded into the main memory. The software modules include an acquisition module, an image-processing module, a recognition module, an attribute-generation module, an analytics module, a prompt-construction module, a generative-model interface module, a UI-generation module, an emotion-analytics module, and a report-generation module. The server communicates with one or more terminals via a wired or wireless communication network.
The server uses general-purpose computing hardware, such as a central processing unit and optionally a graphics processing unit, to perform intensive numerical computations. The server, in one implementation, uses an image-processing software library, a tensor computation library, and a deep-learning framework. The server also uses a database management system to store structured attribute data and analysis results. The server may use a Web server and an application framework to provide interfaces to terminals.
The terminal is, in one embodiment, a portable electronic apparatus such as a smartphone or a tablet computer, including a processor, a memory, a camera, a microphone, a display, and a wireless communication interface. The terminal executes an application program that communicates with the server, displays barrier-free information, acquires visual information in a facility, and acquires user emotion-related information and interaction logs. In another embodiment, the terminal is a fixed display terminal installed in a facility.
The user operates the terminal to acquire visual information and to view barrier-free information. The user may be an end-user who seeks accessibility information, or a facility manager who reviews internal reports and improvement proposals.
The server uses the acquisition module to obtain visual information and structural information related to a facility. The visual information includes still image data and moving image data captured by a camera of the terminal or by other imaging apparatuses installed in the facility. The structural information includes layout descriptions, floor maps, equipment lists, and parameterized representations such as coordinates of corridors and rooms. The structural information is stored in a structured data store, for example as records in a relational table containing fields for facility identifier, floor identifier, spatial coordinates, and equipment type codes.
The server uses the image-processing module to perform preprocessing on the visual information. The server converts image formats if necessary, normalizes image sizes to standard resolutions, and applies intensity normalization. The server applies spatial filters such as Gaussian filters for noise reduction and edge-detection filters to facilitate segmentation and object detection. The server extracts keyframes from videos at regular temporal intervals and treats each keyframe as an individual image sample. This preprocessing produces normalized, noise-reduced images that improve subsequent recognition accuracy and reduce computational load by discarding redundant frames.
The server uses the recognition module to detect equipment elements related to barrier-free use from the preprocessed images. In one embodiment, the recognition module implements a convolutional neural network-based object detection model. The server may employ a one-stage detector architecture with a backbone convolutional network, a feature pyramid network, and detection heads that output bounding boxes and class probabilities. The backbone network may consist of multiple convolutional layers with batch normalization and nonlinear activation functions, followed by downsampling layers. The server trains the recognition model offline using training data sets containing annotated images of facility components such as level differences, lifting devices, inclined passages, entrances, and sanitary installations.
The server uses a supervised learning process to train the recognition model. The server uses a loss function that is a weighted combination of localization loss and classification loss. The localization loss may be a regression loss between predicted bounding boxes and ground-truth bounding boxes, whereas the classification loss may be a cross-entropy loss over equipment element classes. The server performs gradient-based optimization, such as stochastic gradient descent or an adaptive optimization method, to update the network weights. The server optionally applies data-augmentation techniques, such as random cropping, rotation, scaling, and color jittering, to improve robustness against variations of lighting and viewpoints.
The server, when executing inference, receives a preprocessed image and outputs a set of detections, where each detection includes a class label, a bounding box, and a confidence score. The server filters detections based on a confidence threshold and performs non-maximum suppression to remove overlapping boxes for the same equipment element.
This processing yields a set of detected facility components with associated positional coordinates and confidence values.
The server uses the attribute-generation module to convert detection results and structural information into attribute data indicating a barrier-free state of the facility. The server, for each facility and relevant spatial region, aggregates detections into feature vectors. A feature vector may include, for example, the number of detected level differences, a boolean indicator of presence of at least one inclined passage, the number and positions of lifting devices, and distances between entrances and nearest lifting devices. The server uses a data-analysis library to group detections by facility identifier, floor identifier, and area identifier, and to compute statistics such as counts, average distances, and ratio values.
The server stores the attribute data as records in a facility-attribute table. Each record may include fields for facility identifier, area identifier, a set of boolean flags indicating presence or absence of certain equipment elements, and numerical fields representing distances, counts, and accessibility scores. This structuring enables efficient querying and reduces the amount of data that must be sent to downstream modules. By storing compact attribute vectors instead of full-resolution images, the server reduces memory and network bandwidth requirements.
The server uses the analytics module to compute evaluation indicators from the attribute data. The evaluation indicators quantify, for example, a degree of compliance with predetermined accessibility standards. The server compares attribute values with threshold values defined in a rule set. For instance, the server computes an indicator representing “distance to nearest lifting device” and compares it with a permissible maximum distance. The server assigns categorical ratings, such as “sufficient,” “marginal,” or “deficient,” to each region. The server stores evaluation indicators in an evaluation table linked to the facility-attribute table. This preprocessing allows the subsequent generative AI processing to be guided by precise numerical data instead of relying on generic descriptions.
The server uses the prompt-construction module to construct prompt sentences that control a generative AI model. The generative AI model may be a large-scale language model based on a transformer architecture. Such a model includes an embedding layer, multiple self-attention layers, feed-forward layers, and layer-normalization units. The transformer model is trained on large corpora of text data using maximum-likelihood training, where the model learns to predict the next token given previous tokens. The server interfaces with this pre-trained generative AI model through an application programming interface.
The server, in the prompt-construction module, converts attribute data and evaluation indicators into text fragments with specific formatting rules. For example, the server generates a tabular description encoded as a text block, describing each relevant area, equipment presence, and indicator value. The server then embeds this text block into a template prompt sentence. One example of a prompt sentence is:
“Here is the barrier-free data for Facility A: 3 entrances, 1 has a ramp, 2 have steps without ramps; 1 elevator located at the south side; accessible toilet only on the second floor. Analyze these data and describe current accessibility. Then propose concrete improvements for wheelchair users.”
Another example of a prompt sentence is:
“The user searched for barrier-free cafés around Shinjuku Station. Here is the raw data for candidate cafés: [structured data]. Summarize and rank these cafés based on wheelchair accessibility, presence of elevators, and accessible restrooms.”
The server may construct additional prompt sentences for rewriting specific content based on emotion analysis, such as:
“Users frequently show confusion when reading the elevator information section for this facility. Here are the current text and icons: [current content]. Please rewrite this content in clearer and more reassuring language.”
The server may also construct a prompt sentence for generating facility-improvement plans, such as:
“Based on user feedback and barrier-free data for this shopping mall, users complain about insufficient ramps at entrances B and C. Generate a prioritized improvement plan that specifies where to install additional ramps and how to communicate these changes to users.” By embedding structured attribute data and evaluation indicators into the prompt sentences, the server constrains and guides the generative AI model. This reduces ambiguity and improves consistency and accuracy of the generated text. The server thereby uses the generative AI model in a way that is technically integrated with the server's data structures and analytics computations.
The server uses the generative-model interface module to call the generative AI model. The server transmits the prompt sentence and, optionally, supplementary contextual text, to the generative AI model. The server sets parameters such as a maximum number of tokens and a temperature parameter for controlling variability of outputs. The generative AI model, based on its internal transformer architecture, iteratively computes attention weights and updates hidden states to generate a sequence of output tokens. The server receives the output tokens and reconstructs them into natural-language text strings.
The server uses the UI-generation module to create display data that define information display screens. The server uses a template engine to combine explanatory text, improvement-proposal text, and attribute data into a structured layout. The server inserts icons representing equipment elements at positions corresponding to their locations in the facility. The server displays evaluation indicators as grade markers or colored bars. The server may generate responsive layouts suitable for different screen sizes.
The terminal receives the display data and renders the information display screens on a user-facing display unit. The terminal may use a browser engine or a native rendering engine to interpret the display data. The terminal may support interactive elements, such as buttons for switching floors or filtering by type of barrier-free facility.
The user views the information display screens on the terminal. The user may scroll through lists, tap on icons to view detailed explanations, or switch between overview and detailed views. The user can provide explicit evaluation information via rating controls or comment fields. The user can also move through the facility while observing suggested barrier-free routes and verifying physical conditions.
The terminal uses an emotion-capture module to collect emotion-related data. The terminal, with user consent, activates its camera and microphone while the user views barrier-free information. The terminal captures facial images and voice segments at intervals. The terminal performs face detection and facial-landmark extraction using a lightweight convolutional model. The terminal computes feature vectors that represent facial expressions. The terminal transmits these feature vectors or cropped facial images, together with timestamps and screen-region identifiers, to an emotion-recognition processing unit, which may be implemented on the server or in an external service.
The emotion-recognition processing unit executes an emotion-classification model. This model may be a neural network that takes as input facial features or prosodic features of voice signals and outputs probabilities for emotion categories such as joy, confusion, anxiety, and satisfaction. The model may include convolutional layers and fully connected layers with a softmax output. The server trains this model offline using labeled emotion data. During training, the server minimizes a loss function such as cross-entropy between predicted probability distributions and ground-truth labels, and updates model weights using gradient-based optimization. During inference, the model outputs emotion-state information with confidence scores. The server associates emotion-state information with screen regions and time intervals.
The terminal also uses a logging module to record operation-history information. This information includes scroll positions, tap events, time durations spent on each content section, and navigational transitions between screens. The terminal sends the operation-history information to the server along with emotion-state information identifiers. The server uses the emotion-analytics module to analyze operation-history information and emotion-state information. The server joins emotion records with interaction logs based on timestamps and region identifiers. The server computes metrics for each screen component, such as an average time to first interaction, an average viewing duration, and a distribution of emotion categories while that component is visible. The server identifies components that tend to evoke confusion or anxiety and components that evoke satisfaction or relief. The server uses these analysis results to generate update data for modifying the layout or explanatory content. For example, the server may decide to move a component with high positive emotion responses to a more prominent position, or to request rephrasing of a component associated with negative emotions. The server may construct a specific prompt sentence instructing the generative AI model to rewrite particular sections. The server, after obtaining updated text, modifies the template data and sends updated display data to terminals. In this way, the system achieves an adaptive interface that continuously improves based on quantified emotion and interaction data.
The server uses the report-generation module to produce internal management-screen data and report data for facility managers. The server aggregates attribute data, evaluation indicators, user feedback, and emotion-analytics results across multiple time periods. The server computes facility-level scores and identifies trends, such as improvement or degradation of accessibility metrics. The server may generate charts and maps, for example using a data visualization library, to illustrate density of level differences or coverage of lifting devices.
The server constructs a prompt sentence that summarizes analysis results and requests an improvement-proposal text, such as:
“Analyze this facility's barrier-free information, identify problems such as missing elevators or ramps, and propose concrete improvement measures.”
The server sends this prompt to the generative AI model, receives a structured improvement-proposal text, and formats it into a report or a management dashboard. The facility manager can view these materials, but the technical improvement resides in how the server integrates raw sensor-level data, structured attributes, analytics, and generative AI control within the computing system.
The described architecture improves computer technology in several ways. First, the server transforms high-volume visual data into compact attribute data and evaluation indicators, which reduces storage and network load and accelerates downstream processing. Second, the server uses structured prompt construction based on these attribute data to more effectively control the generative AI model, leading to higher accuracy and consistency of generated text and reducing the need for manual correction. Third, the server integrates emotion-state information and operation-history information into the data flow, enabling programmatic adaptation of user interfaces in ways that are not feasible with static templates. This adaptive behavior reduces user search time and improves the probability that users quickly find relevant barrier-free information.
Furthermore, the system applies non-conventional processing rules that differ from manual workflows. For example, the server automatically correlates emotion responses with specific UI components and uses this correlation to trigger targeted prompt reconstruction and selective re-generation of only affected text sections. This fine-grained control and feedback loop cannot be achieved by simple automation of human editing; instead, it leverages the internal state and attention mechanisms of transformer-based language models guided by structured features computed on the server.
In addition, the described training and inference procedures for recognition and emotion models, including specific loss functions, optimization processes, and data-augmentation strategies, improve detection and classification accuracy. Higher accuracy of equipment detection and emotion estimation directly improves the quality of attribute data and analytics, which in turn improves the quality of prompt sentences and generated content. The server's modular design, with distinct yet interconnected modules and well-defined data structures, facilitates efficient computation, parallel processing, and scalable deployment.
In alternative embodiments, the server may use different deep-learning architectures, such as two-stage detectors for object recognition or recurrent networks for emotion classification. The server may use different data stores, such as a document-oriented database for storing attribute records or a time-series database for storing emotion-analytics logs. The terminal may implement more or less processing locally, for instance performing initial facial-feature extraction on-device to further reduce network load.
In another embodiment, the server may run the generative AI model locally instead of calling a remote service, and may adjust model hyperparameters for different usage scenarios. The server may schedule periodic re-training of recognition and emotion models using newly collected labeled data, thereby adapting to new facility types and user populations.
In a further embodiment, the system may be applied to different kinds of facilities, such as transportation hubs, commercial centers, or public buildings, by altering the structural information schema and training data sets, while reusing the same technical architecture and data flow. In all such variations, the core concept remains that the server programmatically transforms raw multi-modal inputs into structured attribute data, constructs data-rich prompt sentences to control a generative AI model, and uses integrated analytics of user interaction and emotion-state information to adapt both user-facing information presentation and facility-improvement proposals.

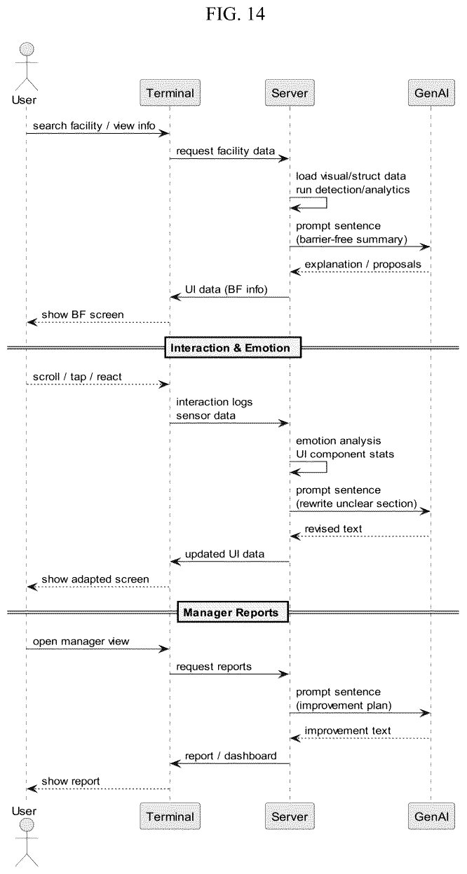

The following describes the processing flow using FIG. 14.
Step 1:
Server acquires facility visual information and structural information.
Server receives, as input, image files and video files captured by cameras of terminals or installed imaging devices, together with structural records such as floor plans and equipment lists. Server validates file formats and metadata, then stores the raw visual information in a storage device and the structural information in a database. Server associates a facility identifier, floor identifier, and timestamp with each stored item so that later processing modules can retrieve consistent sets of data as output (a linked collection of visual data paths and structural records).
Step 2:
Server preprocesses the visual information for recognition.
Server reads, as input, raw image frames and video frames from storage. Server resizes each frame to a standard resolution, normalizes pixel intensities, and applies noise-reduction filters. Server also extracts keyframes from video at predefined intervals. Server thus converts heterogeneous raw visual data into normalized, noise-reduced image tensors as output, suitable for input to recognition models and reducing computational load.
Step 3:
Server detects barrier-free related equipment elements from preprocessed images.
Server takes, as input, preprocessed image tensors and applies a trained object-detection model implemented by a convolutional neural network. Server executes convolution, pooling, and activation operations layer by layer, computes bounding boxes and class probabilities for each candidate region, and then filters detections by confidence thresholds and performs non-maximum suppression. Server outputs a set of detection records, each containing a facility identifier, image identifier, class label (for example, level difference, lifting device, inclined passage, entrance, sanitary installation), bounding box coordinates, and confidence score.
Step 4:
Server converts detection results and structural information into barrier-free attribute data.
Server receives, as input, the detection records from Step 3 and structural records from Step 1. Server groups detections by facility, floor, and area, and computes counts (for example, number of level differences), boolean flags (for example, presence of at least one inclined passage), and distances between equipment elements (for example, distance from entrance to nearest lifting device), using coordinate data from structural records. Server writes, as output, one attribute record per area into a facility-attribute table, where each record contains compact feature vectors describing the barrier-free state.
Step 5:
Server computes evaluation indicators from attribute data.
Server uses, as input, the attribute records generated in Step 4. Server applies rule-based comparisons and arithmetic operations to derive indicators such as accessibility scores, compliance flags, and deficiency levels. For example, server calculates distance-to-elevator indicators and compares them to predefined thresholds to assign “sufficient” or “deficient” labels. Server outputs evaluation indicator records linked to each attribute record, storing them in an evaluation table for fast lookup.
Step 6:
Server constructs a prompt sentence for the generative AI model based on attribute data and evaluation indicators.
Server reads, as input, selected attribute records and corresponding evaluation indicators for a target facility or area. Server converts numeric and boolean values into formatted text fragments (for example, “3 entrances, 1 ramp, 2 entrances with steps and no ramps”), and concatenates these fragments into a structured instruction. Server embeds the formatted data into a template to form a complete prompt sentence, such as:
“Here is the barrier-free data for Facility A: 3 entrances, 1 has a ramp, 2 have steps without ramps; 1 elevator located at the south side; accessible toilet only on the second floor. Analyze these data and describe current accessibility. Then propose concrete improvements for wheelchair users.”
Server outputs this prompt sentence as a text string ready for input to the generative AI model.
Step 7:
Server invokes the generative AI model with the constructed prompt sentence.
Server takes, as input, the prompt sentence from Step 6 and optional additional context text.
Server sends these as parameters to an external or internal generative AI model interface, specifying model options such as maximum token length and temperature. The generative AI model computes, internally, attention weights and token probabilities and returns generated tokens. Server reconstructs these tokens into natural-language text. Server outputs two types of text: an explanatory text describing current barrier-free conditions and an improvement-proposal text suggesting enhancements.
Step 8:
Server generates user-facing display data from attribute data and AI-generated text.
Server uses, as input, the attribute data from Step 4, evaluation indicators from Step 5, and explanatory and improvement-proposal texts from Step 7. Server applies a template engine to map attribute values to icons, tables, and graphs, and inserts the AI-generated paragraphs into designated regions of a screen layout definition. Server computes layout parameters such as section ordering and emphasis levels. Server outputs display data (for example, HTML and style definitions or structured UI configuration) that fully define an information display screen for the terminal.
Step 9:
Terminal requests and renders barrier-free information screens.
Terminal receives, as input, a user operation indicating a request for information on a given facility (for example, a selection in an application). Terminal sends a request to the server specifying the facility identifier. Terminal then receives the display data from Step 8. Terminal parses the layout and content elements and renders them on its display unit, drawing icons, text, and interactive elements. Terminal outputs a visible information display screen that the user can view and interact with.
Step 10:
User searches for facilities and views barrier-free information.
User provides, as input, search text such as “barrier-free café near Shinjuku Station” or selects a facility from a list on the terminal interface. User receives, as output, a list of candidate facilities and, upon selection, detailed barrier-free information rendered by the terminal. User may scroll, tap icons for more details, or switch between overview maps and detailed sections, thereby generating interaction events.
Step 11:
Terminal logs user interaction events as operation-history information.
Terminal accepts, as input, low-level events from the user interface, including scroll events, tap positions, selection changes, and dwell times on individual screen sections. Terminal transforms these events into structured log entries containing timestamps, screen-region identifiers, and event types. Terminal batches these entries and sends them to the server.
Terminal outputs, for the server, a stream of operation-history records that represent how the user navigated the barrier-free information.
Step 12:
Terminal captures emotion-related sensor data while the user views information.
Terminal receives, as input, user consent and system settings enabling emotion capture.
Terminal then periodically captures camera frames of the user's face and audio segments of the user's voice while barrier-free screens are displayed. Terminal applies basic face detection or audio segmentation to crop relevant regions and associates each capture with a timestamp and current screen-region identifier. Terminal outputs preprocessed facial images or audio snippets and sends them to an emotion-recognition processing unit on the server or another computing resource.
Step 13:
Server performs emotion recognition and generates emotion-state information.
Server takes, as input, facial images or audio segments and their associated metadata from Step 12. Server feeds feature representations (for example, facial landmarks or spectrogram features) into a trained emotion-classification model implemented as a neural network. Server computes, for each sample, probability scores over emotion categories such as joy, confusion, anxiety, and satisfaction. Server selects the most probable emotion and records its confidence score. Server outputs emotion-state records linked to user identifiers, timestamps, and screen-region identifiers.
Step 14:
Server correlates operation-history information with emotion-state information.
Server receives, as input, operation-history records from Step 11 and emotion-state records from Step 13. Server joins these data sets based on timestamps and screen-region identifiers, thereby associating specific user actions and viewed components with detected emotions. Server aggregates per-component metrics, such as average emotion distribution while a section is visible and typical dwell time before a user scrolls away. Server outputs component-level analytics records indicating, for each UI element or content section, which emotions it tends to evoke and how users interact with it.
Step 15:
Server analyzes component-level analytics and identifies sections requiring adaptation. Server uses, as input, the component-level analytics records from Step 14 and evaluation indicators from Step 5. Server applies thresholds and rules to detect problematic sections, for example, sections that combine high confusion rates with long dwell times or repeated back-and-forth navigation. Server marks such sections as candidates for layout changes or content rewriting. Server outputs an adaptation plan record that lists sections to promote, demote, or rewrite, and the type of adaptation required.
Step 16:
Server constructs new prompt sentences for content rewriting based on emotion analytics. Server accepts, as input, the adaptation plan from Step 15 and the current content texts for affected sections. Server builds prompt sentences that describe user reactions and include the current content as context. For example, server may generate a prompt such as:
“Users frequently show confusion when reading the elevator information section for this facility. Here are the current text and icons: [current content]. Please rewrite this content in clearer and more reassuring language.”
Server outputs one or more prompt sentences, each tailored to a specific section and adaptation goal.
Step 17:
Server invokes the generative AI model to produce adapted content.
Server takes, as input, the prompt sentences from Step 16. Server sends each prompt sentence to the generative AI model with parameters tuned for rewriting tasks (for example, moderate temperature and constrained maximum length). Server receives, as output, revised explanatory texts that are expected to be clearer and more reassuring, based on the model's learned language patterns. Server validates that required information is still present and stores the revised texts as updated content records.
Step 18:
Server updates UI templates and regenerates display data with adapted content.
Server uses, as input, the adaptation plan from Step 15 and the revised texts from Step 17. Server modifies layout descriptors (for example, moving high-value sections to more prominent positions) and replaces original texts with revised versions in the template definitions. Server then re-runs the UI-generation module logic similar to Step 8 to create new display data that incorporate the updated layout and content. Server outputs updated display data for distribution to terminals.
Step 19:
Terminal receives updated display data and refreshes the information display screen.
Terminal takes, as input, updated display data pushed by the server or requested during the next access. Terminal compares version identifiers and determines that newer layout and content are available. Terminal re-renders the barrier-free information screen according to the updated definitions, so that the user now sees rearranged components and rewritten explanations. Terminal outputs the refreshed screen, thereby closing the feedback loop initiated by emotion and interaction analysis.
Step 20:
User provides explicit evaluation information about barrier-free information and usability. User inputs, via the terminal interface, ratings and textual comments regarding the clarity, completeness, and usefulness of displayed barrier-free information. User may, for example, select a numerical satisfaction level or write “the map is hard to understand.” User's inputs are transmitted by the terminal as structured evaluation records. User thus provides explicit qualitative and quantitative feedback as output for the server.
Step 21:
Server integrates explicit user evaluation with attribute data and analytics.
Server receives, as input, evaluation records from Step 20, attribute data from Step 4, and analytics results from Steps 14 and 15. Server merges these data sets based on facility identifiers and time ranges. Server computes aggregate feedback metrics, such as the frequency of specific complaints about ramps or elevators. Server outputs integrated feedback-and-analytics records that summarize user perceptions alongside measured barrier-free attributes.
Step 22:
Server constructs facility-improvement prompt sentences for the generative AI model. Server uses, as input, the integrated feedback-and-analytics records from Step 21 and evaluation indicators from Step 5. Server composes prompt sentences that describe current conditions, highlight specific deficiencies, and request actionable improvement plans. For example, server may create a prompt such as:
“Based on user feedback and barrier-free data for this shopping mall, users complain about insufficient ramps at entrances B and C. Generate a prioritized improvement plan that specifies where to install additional ramps and how to communicate these changes to users.” Server outputs these facility-improvement prompt sentences as text instructions.
Step 23:
Server obtains improvement-proposal texts from the generative AI model.
Server provides, as input, the facility-improvement prompt sentences from Step 22 to the generative AI model. Server receives, as output, structured improvement-proposal texts that enumerate recommended physical changes (for example, installing additional ramps, relocating signage, or adding lifting devices) and communication strategies. Server stores these texts as improvement-proposal records associated with each facility.
Step 24:
Server generates management-screen data and report data for facility managers.
Server takes, as input, improvement-proposal records from Step 23, attribute and evaluation data from Steps 4 and 5, and analytics summaries from previous steps. Server creates management-screen layouts that include charts, maps, and the AI-generated proposals, and formats report documents summarizing the barrier-free status and planned improvements. Server outputs management-screen data for interactive dashboards and report data for downloadable documents.
Step 25:
User (facility manager) accesses and acts on management information.
User, acting as a facility manager, logs into a dashboard on a terminal and requests information for a specific facility. User receives, as output, management screens generated in Step 24 that show metrics, maps, and improvement proposals. User may then decide to initiate physical modifications or policy changes. Although this decision-making is human, the technical system has already processed data, generated structured proposals, and optimized presentation based on computing operations that go beyond simple automation. Through these steps, server, terminal, and user cooperate so that the server performs structured data transformations, analytics, and generative AI control guided by prompt sentences, the terminal captures interaction and emotion signals, and the user benefits from adaptive, technically enhanced barrier-free information and improvement guidance.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

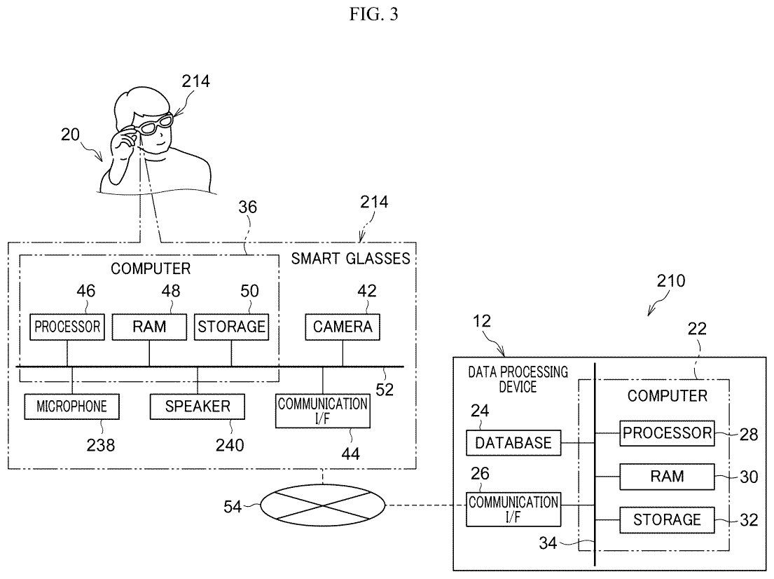

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

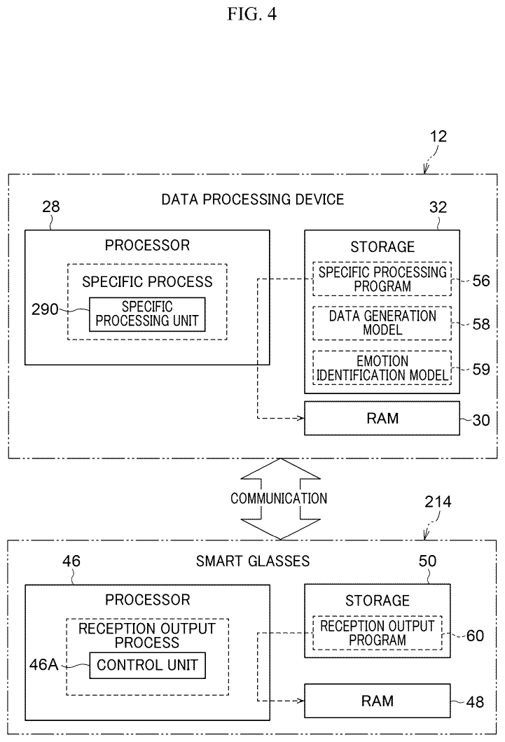

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

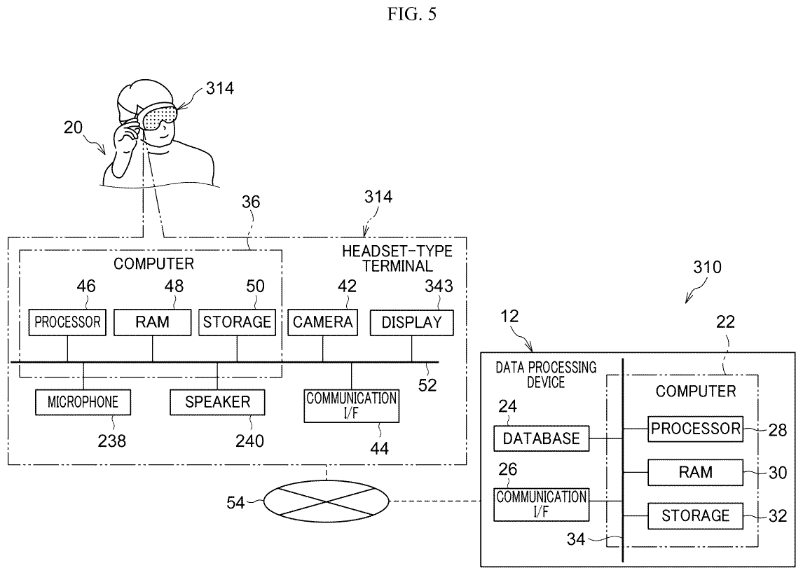

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

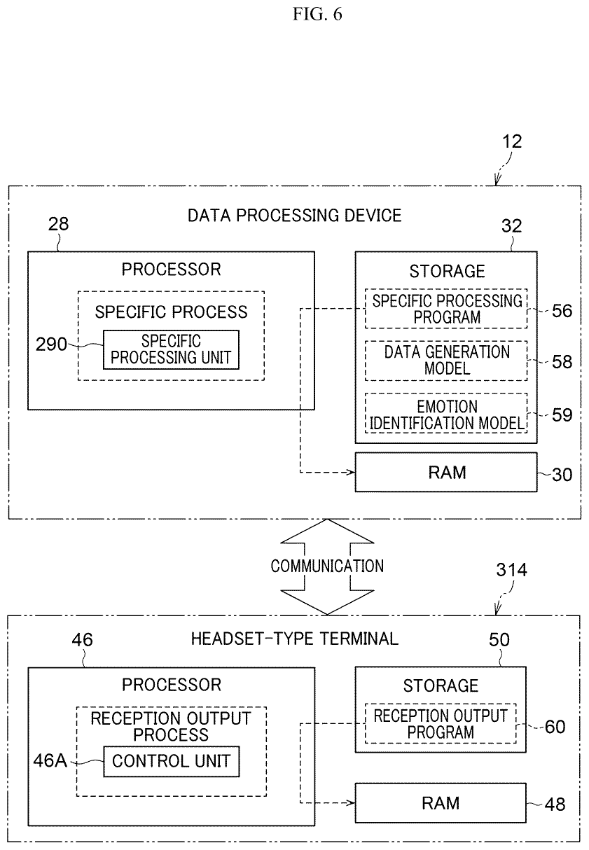

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

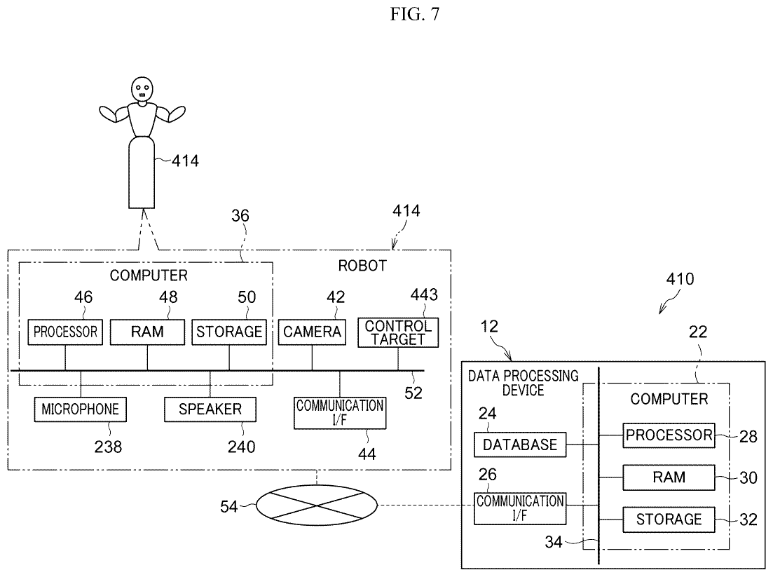

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

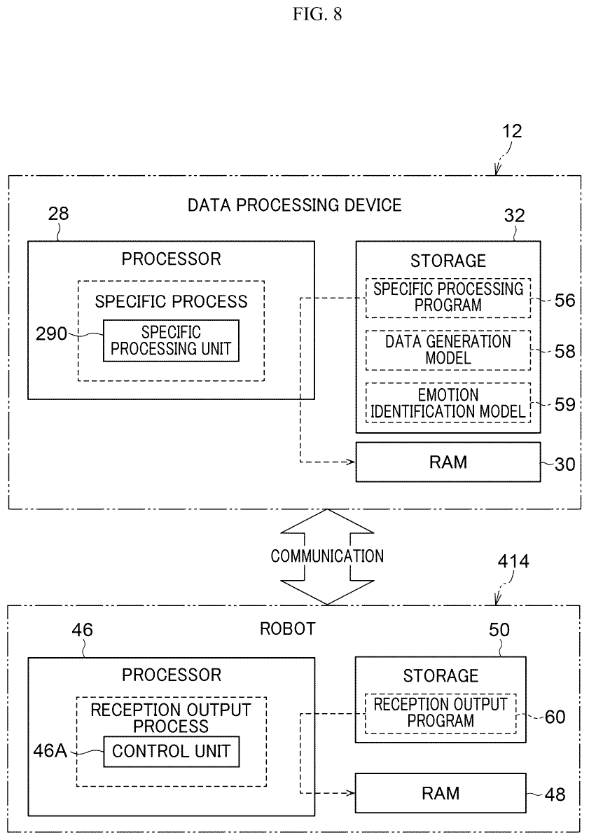

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

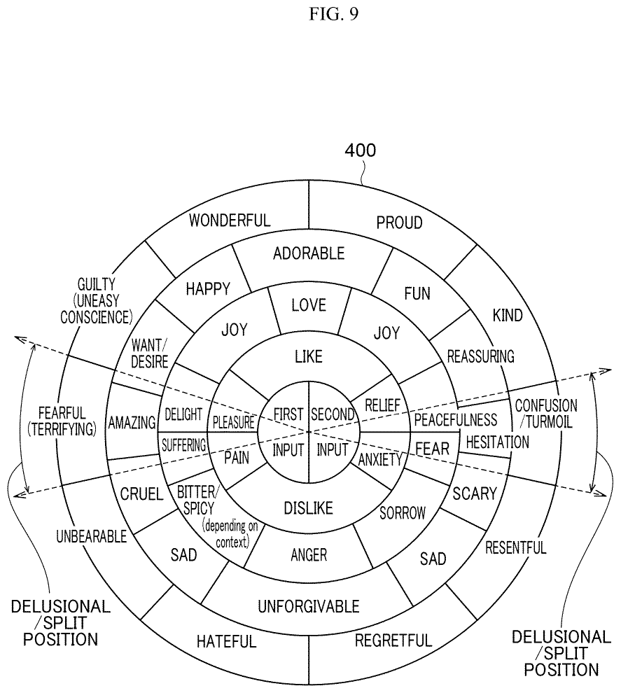

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

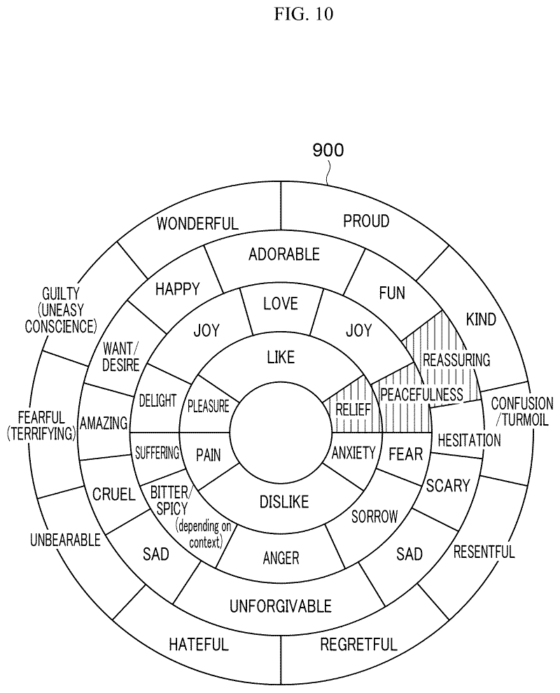

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to receive visual data of a facility transmitted from a user terminal and convert the visual data into analysis target data that is pre-processable,
execute an image recognition process using machine learning on the analysis target data to extract barrier-free related features including presence or absence of level differences,
installation status of lifting equipment, and accessibility status of sanitary equipment,
generate structured data that defines contents of barrier-free information based on the barrier-free related features, automatically generate a prompt sentence for instructing a generative information processing model to generate a natural-language description using the structured data, and input the prompt sentence into the generative information processing model,
acquire a natural-language explanation of the barrier-free information output from the generative information processing model and display the natural-language explanation together with the structured data via a user interface,
automatically generate improvement proposal information that contributes to promotion of barrier-free adaptation of the facility based on user feedback information acquired via the user interface and the barrier-free related features, and
convert the barrier-free information and the improvement proposal information into a format publishable to an information providing medium and distribute the barrier-free information and the improvement proposal information to the information providing medium.

### Supplementary 2

The system according to supplementary 1,
wherein the processor is configured to generate the prompt sentence by embedding the structured data indicating the barrier-free related features into the prompt sentence so as to instruct the generative information processing model to generate the barrier-free information reflecting the barrier-free related features.

### Supplementary 3

The system according to supplementary 1,
wherein the processor is configured to generate the improvement proposal information including proposal contents relating to addition, modification, or rearrangement of structural elements or equipment elements of the facility, based on the user feedback information and the barrier-free related features.

### Application Example 1

### Supplementary 1

A system comprising a processor and a storage device,
wherein the processor is configured to receive visual data of a facility and store the visual data in the storage device,
extract, by using a general-purpose image processing program or a general-purpose image processing library, feature values related to barrier-free structures from the visual data,
execute, by using a general-purpose machine learning framework, inference processing on the feature values or on the visual data to generate barrier-free information including at least one of presence or absence of level differences, installation status of lifting equipment, and accessibility status of sanitary equipment,
construct a prompt sentence for input to a generative artificial intelligence model on the basis of the generated barrier-free information, and input the prompt sentence and at least one of the visual data and the barrier-free information into the generative artificial intelligence model to cause the generative artificial intelligence model to generate explanation information in natural language,
store the barrier-free information and the explanation information as structured data in the storage device in association with facility identification information, and provide the structured data to a terminal device in response to an acquisition request from the terminal device,
cause the terminal device to display the barrier-free information and the explanation information via a user display unit of the terminal device, and receive evaluation information or comment information from a user as feedback information, and
generate, on the basis of the feedback information and the barrier-free information, an improvement plan for barrier-free measures in the facility, and store the improvement plan as part of the structured data in the storage device.

### Supplementary 2

The system according to supplementary 1,
wherein the processor is configured to automatically generate the prompt sentence on the basis of a template by using metadata including the feature values and the barrier-free information, and input the prompt sentence into the generative artificial intelligence model to cause the generative artificial intelligence model to generate barrier-free explanation information.

### Supplementary 3

The system according to supplementary 1,
wherein the processor is configured to analyze, by using at least one of machine learning processing and rule-based processing, an evaluation value or text information included in the feedback information, and automatically generate the improvement plan that contributes to promotion of barrier-free measures including at least one of elimination of level differences, increase of lifting equipment, and renovation of sanitary equipment.

### Example 2

### Supplementary 1

A system comprising a processor,
wherein the processor is configured to acquire attribute information related to a facility from a user terminal and store the attribute information as structured data,
generate a prompt sentence based on the structured data to instruct a generative artificial intelligence model to generate barrier-free information, input the prompt sentence to the generative artificial intelligence model, and obtain a natural-language explanation including the barrier-free information from the generative artificial intelligence model,
dynamically generate markup language data having a standardized document structure by template processing based on the barrier-free information and the natural-language explanation,
add decorative information for visual representation to the markup language data to generate information display data and distribute the information display data to an information-providing medium, and
update at least one of the structured data and the barrier-free information based on user feedback acquired via the information-providing medium, and regenerate the prompt sentence and the information display data in accordance with the update.

### Supplementary 2

The system according to supplementary 1,
wherein the processor is configured to organize features of the facility extracted from the structured data as a set of attributes expressed by higher-level concepts, and input a prompt sentence including the set of attributes to the generative artificial intelligence model.

### Supplementary 3

The system according to supplementary 1,
wherein the processor is configured to input, to the generative artificial intelligence model, a prompt sentence that instructs generation of an improvement proposal using the user feedback as input, obtain from the generative artificial intelligence model an improvement proposal related to promotion of barrier-free adaptation of the facility, and include the improvement proposal in the information display data.

### Application Example 2

### Supplementary 1

A system comprising a processor,
wherein the processor is configured to acquire visual information and structural information related to a facility, extract equipment elements related to use by persons with disabilities from the visual information by using information processing algorithms and recognition models, and generate attribute data indicating a barrier-free state of each facility based on the extracted equipment elements and the structural information; and
construct, based on the attribute data and evaluation indicators derived from the attribute data, a prompt sentence as an instruction text for a generative AI model to generate barrier-free information and improvement proposals, supply input data including the prompt sentence to the generative AI model, and obtain, from the generative AI model, a natural-language explanatory text and a natural-language improvement-proposal text; and
generate display data for configuring an information display screen that presents barrier-free information of the facility, by using the explanatory text, the improvement-proposal text, and the attribute data, transmit the display data via a communication path to an information terminal, and cause a user-facing display unit of the information terminal to output the information display screen; and
receive, from the information terminal, operation-history information of a user and emotion-state information estimated by an emotion-recognition processing unit, associate the operation-history information and the emotion-state information with components of the information display screen, analyze the associated information, and generate update data for updating at least one of a layout of the information display screen and explanatory content of the information display screen based on a result of the analysis; and
obtain evaluation information from the user via the information terminal, integrate the evaluation information and the result of the analysis with the attribute data and the evaluation indicators, construct an additional prompt sentence as an additional instruction text for the generative AI model to automatically generate an improvement-proposal text for promoting barrier-free enhancement of the facility, input the additional prompt sentence to the generative AI model, obtain the improvement-proposal text from the generative AI model, and output the improvement-proposal text as management-screen data or report data for a facility manager.

### Supplementary 2

The system according to supplementary 1,
wherein the processor is configured to detect, from the visual information related to the facility, facility components including level differences, lifting devices, inclined passages, entrances, and sanitary installations by using image-processing algorithms and trained recognition models, aggregate feature data indicating the detected facility components to generate the attribute data, and embed the feature data and the attribute data into the prompt sentence in order to instruct the generative AI model to generate the barrier-free information.

### Supplementary 3

The system according to supplementary 1,
wherein the processor is configured to integrate and analyze the evaluation information, the operation-history information, and the emotion-state information received from the information terminal, determine, based on a result of the analysis and the attribute data and the evaluation indicators, improvement content including at least one of additional arrangement positions of barrier-free equipment, improvement items of guidance information, and adjustment items of an information-presentation method, and input a prompt sentence including the improvement content to the generative AI model so as to automatically generate an improvement-proposal text contributing to promotion of barrier-free enhancement of the facility.

What is claimed is:

1. A system comprising:
circuitry configured to:
receive, via a communication interface coupled to a packet-switched network, image data representing a physical environment from a terminal device;
extract feature data from the image data using an image processing algorithm;
generate instruction data based on the feature data and transmit the instruction data to a generative model to cause the generative model to output descriptive data characterizing structural attributes of the physical environment;
generate display data based on the descriptive data and transmit the display data to the terminal device via the communication interface for presentation on a display unit; and
receive feedback data from the terminal device, analyze the feedback data in conjunction with the descriptive data, and generate proposal data indicating modifications to the physical environment based on a result of the analysis.

2. The system according to claim 1, wherein the circuitry is configured to:
detect, from the image data, structural elements comprising at least one of level differences, lifting devices, inclined passages, entrances, or sanitary installations using a trained recognition model.

3. The system according to claim 2, wherein the circuitry is configured to:
aggregate feature data indicating the detected structural elements to generate attribute data, and
embed the attribute data into the instruction data to direct the generative model to generate the descriptive data specific to the detected structural elements.

4. The system according to claim 1, wherein the circuitry is configured to:
generate the instruction data as a prompt sentence comprising the feature data and evaluation indicator data derived from the feature data, and
transmit the prompt sentence to the generative model to obtain a natural-language explanatory text and a natural-language proposal text.

5. The system according to claim 4, wherein the circuitry is configured to:
generate the display data by combining the explanatory text, the proposal text, and the attribute data into markup language data having a standardized document structure.

6. The system according to claim 5, wherein the circuitry is configured to:
add decorative information for visual representation to the markup language data, and
distribute the display data to an information-providing medium via the communication interface.

7. The system according to claim 1, wherein the circuitry is configured to:
update at least one of the feature data or the descriptive data based on the feedback data, and
regenerate the instruction data and the display data in accordance with the update.

8. The system according to claim 1, wherein the proposal data comprises at least one of additional arrangement positions for equipment, improvement items for guidance information, or adjustment items for an information-presentation method.

9. The system according to claim 1, wherein the circuitry is configured to:
receive operation-history information and emotion-state information estimated by an emotion-recognition processing unit from the terminal device,
associate the operation-history information and the emotion-state information with components of the display data, and
generate update data for modifying at least one of a layout or explanatory content of the display data based on the associated information.

10. The system according to claim 9, wherein the circuitry is configured to:
integrate evaluation data received from the terminal device with the operation-history information, the emotion-state information, the feature data, and the evaluation indicator data, and
generate an additional instruction data set for the generative model to produce an updated proposal text.

11. The system according to claim 1, wherein the image data comprises at least one of still image data, video data, or a sequence of image frames captured by an imaging device of the terminal device.

12. The system according to claim 1, wherein the generative model comprises a machine learning model having a natural language processing function, and the circuitry is configured to:
cause the generative model to perform semantic analysis on the instruction data and output the descriptive data as structured information representing configuration conditions of the physical environment.

13. The system according to claim 1, wherein the circuitry is configured to:
store the feature data, the descriptive data, and the feedback data in a storage device in association with facility identification information, and
generate report data aggregating the descriptive data and the proposal data for output to a management display apparatus.

14. The system according to claim 1, wherein the circuitry is configured to:
acquire attribute information related to the physical environment from the terminal device, and
store the attribute information as structured data in a storage device for use in generating the instruction data.

15. The system according to claim 1, wherein the circuitry is configured to:
generate a comparison data set comprising the descriptive data and a corresponding portion of the feedback data, and
transmit the comparison data set to the generative model to obtain the proposal data as a natural-language improvement text.

16. The system according to claim 1, wherein the terminal device comprises at least one of a mobile computing device, a wearable display device, a headset-type terminal, or a robotic apparatus, each coupled to the packet-switched network via the communication interface.

17. The system according to claim 16, wherein the terminal device comprises the wearable display device including a microphone and a speaker, and the circuitry is configured to:
receive audio data representing user speech from the wearable display device, and
transmit audio output data to the speaker of the wearable display device.

18. The system according to claim 1, wherein:
the circuitry comprises a processor, a memory storing a program, a communication interface, and a storage device,
the processor executes the program to implement the extraction of the feature data and the generation of the instruction data,
the storage device stores the image data, the feature data, the descriptive data, and the proposal data, and
the communication interface exchanges data with the terminal device over the packet-switched network.

19. The system according to claim 18, wherein the storage device comprises a facility database that associates facility identification information with attribute data, feature data, and feedback records.

20. A method performed by circuitry, the method comprising:
receiving, via a communication interface coupled to a packet-switched network, image data representing a physical environment from a terminal device;
extracting feature data from the image data using an image processing algorithm;
generating instruction data based on the feature data and transmitting the instruction data to a generative model to cause the generative model to output descriptive data characterizing structural attributes of the physical environment;
generating display data based on the descriptive data and transmitting the display data to the terminal device via the communication interface for presentation on a display unit; and
receiving feedback data from the terminal device, analyzing the feedback data in conjunction with the descriptive data, and generating proposal data indicating modifications to the physical environment based on a result of the analysis.
